(19) United States
(12) Patent Application Publication
(10) Pub. No.: US 2012/0263850 A1
(43) Pub. Date: Oct. 18, 2012

(54) Composition

(75) Inventors: Lars MÅNSSON, Brabrand (DK); S.P. Janaka Namal SENANAYAKE, New Century, KS (US)

(73) Assignee: DuPont Nutrition BioScience ApS, Copenhagen K (DK)

(21) Appl. No.: 13/425,014

(22) Filed: Mar. 20, 2012

Related U.S. Application Data
(63) Continuation-in-part of application No. PCT/IB2010/054637, filed on Oct. 13, 2010.
(60) Provisional application No. 61/454,689, filed on Mar. 21, 2011.

(30) Foreign Application Priority Data
Oct. 15, 2009 (GB) 0918074.6
Jul. 8, 2010 (GB) 1011487.4

(51) Int. Cl. C11B 5/00; A23D 7/005

(52) U.S. Cl. 426/542

(57) ABSTRACT

The present invention provides a foodstuff in the form of a spread, wherein the spread is a water in oil emulsion containing an anti-oxidant composition comprising
(a) an extract obtained from or obtainable from a plant of the Labiatae family,
(b) an extract obtained from or obtainable from a plant of the genus Matricaria or of the genus Chamaemelum.

### CLAIM FOR PRIORITY

This application claims priority under 35 U.S.C. §119(e) to U.S. Patent Application No. 61/454,689, filed on Mar. 21, 2011, and is a continuation-in-part of International Patent Application No. PCT/IB2010/054637 designating the United States of America, filed Oct. 13, 2010, each of which is hereby incorporated by reference in its entirety.

The present invention relates to a composition that exhibits an anti-oxidant action.

### BACKGROUND

Antioxidants are widely used in food products susceptible to oxidative degeneration. An antioxidant is defined by the Food and Drug Administration (21CFR 170.3) as “a substance used to preserve food by retarding deterioration, rancidity, or discoloration due to oxidation”. There is an increasing need to develop economical, natural and effective food preservative systems to meet the public demand for convenient, natural, safe, healthy, good quality food products with guaranteed shelf life. To this end spices or plant extracts can be used in food as antioxidants and to impart flavour. One advantage of such extracts is that they are perceived as natural ingredients when compared to chemical antioxidants such as ethylenediaminetetraacetic acid (EDTA), butyl hydroxyanisol (BHA) and butylated hydroxytoluene (BHT).

There are large number of antioxidants known based on naturally occurring plant materials. It is noted that these materials have varying degrees of efficacy. Moreover, the antioxidant levels required to ensure preservation safety may prove uneconomical, or are above levels acceptable due to regulatory and legislation constraints when present in amounts sufficient to offer the required protection.

The present invention alleviates the problems of the prior art.

In one aspect the present invention provides a foodstuff in the form of a spread, wherein the spread is a water in oil emulsion containing an anti-oxidant composition comprising
(a) an extract obtained from or obtainable from a plant of the Labiatae family,
(b) an extract obtained from or obtainable from a plant of the genus Matricaria or of the genus Chamaemelum.

In one aspect the present invention provides a process for preventing and/or inhibiting oxidation of a foodstuff which is in the form of a spread, wherein the spread is a water in oil emulsion, the process comprising the step of contacting the spread with or incorporating in the spread
(a) an extract obtained from or obtainable from a plant of the Labiatae family, and
(b) an extract obtained from or obtainable from a plant of the genus Matricaria or of the genus Chamaemelum.

In one aspect the present invention provides use of
(a) an extract obtained from or obtainable from a plant of the Labiatae family, and
(b) an extract obtained from or obtainable from a plant of the genus Matricaria or of the genus Chamaemelum,
   for preventing and/or inhibiting oxidation of a foodstuff which is in the form of a spread, wherein the spread is a water in oil emulsion.

Aspects of the invention are defined in the appended claims.

The present invention provides a combination of components for preventing and/or inhibiting oxidation in a water in oil spread. This combination of components allows lower levels of the antioxidants to be used to provide effective action. This is particularly important in food applications where reduction of dosage is desired for commercial and regulatory reasons.

It will be understood by one skilled in the art that by the term ‘antioxidant’ it is meant a substance which reduces the amount of oxidation over a given period when compared to the oxidation that would occur in the absence of that substance or it is a meant a material which increase the time required for a given amount of oxidation to occur when compared to the oxidation that would occur in the absence of that substance.

Plants of the family Labiatae contain several well known herbs. Extracts from these plants have been shown to have antioxidant and, in some cases, antimicrobial activity (Nychas & Skandamis, 2003; Smid and Gorris, 1999; Loliger, 1989). Such extracts may be essential oils and oleoresins (extracts with essential oil content used in flavours and fragrances) or “deodorised'”, extracts that have a high phenolic diterpene content and low level of flavour-inducing compounds.

Essential oils are extracted by simple steam distillation of the plant material. The most effective antioxidant compounds in rosemary and sage are reported to be carnosic acid, carnosol and rosmarinic acid (Cuvelier et al. 1996). Carnosic acid, a phenolic diterpene (C₂₀H₂₈O₄), occurs naturally in leaves of plants of the Labiatae family, particularly rosemary and sage, but also thyme and marjoram. Dried leaves of rosemary or sage contain 1.5-2.5% carnosic acid and 0.3-0.4% carnosol (U.S. Pat. No. 6,231,896). Carnosol is an oxidative artefact of carnosic acid (Wenkert et al. J. Org. Chem. 30:2931, 1965). The oxidation takes place in the presence of harvesting in the leaves left to dry in the air and if the leaves are subjected to extraction with solvents. Rosmanol may also be a product of the oxidation of carnosic acid.

Of the Labiatae plant family, rosemary and sage have antioxidant activity in foods that is mainly related to phenolic diterpenes such as carnosic acid and carnosol, as well as other phenolic compounds, including phenolic triterpenes such as betulinic acid, oleanolic acid and ursolic acid; and rosmarinic acid. The phenolic diterpenes, phenolic triterpenes and rosmarinic acid are distinct from the essential oils and oleoresins that are often used in flavours and fragrances. The high flavour and odour levels of essential oils is not conducive to their use in food.

Of plants of the genus Matricaria or of the genus Chamaemelum, such as chamomile, are also known to have antioxidant activity. This is mainly related to flavones such as apigenin-7-O-glucoside (A7G) and its derivatives, as well as other flavones.

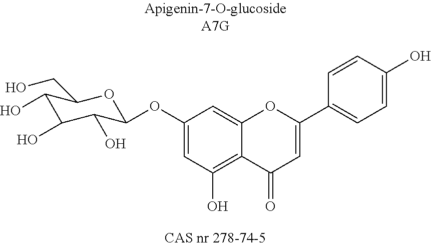

Details of A7G and its derivatives are disclosed by Svehlíková, V et al Phytochemistry, 2004, 35, 2323. As for the active antioxidants of Labiatae plant family, the antioxidants from plants of the genus Matricaria or of the genus Chamaemelum are distinct from the essential oils and oleoresins that are often used in flavours and fragrances. The high flavour and odour levels of essential oils is not conducive to their use in food.

One skilled in the art would expect a combination of an extract from the Labiatae plant family and an extract from a plant of the genus Matricaria or of the genus Chamaemelum, to provide a simple additive antioxidant effect. However, studies described herein have demonstrated synergistic enhancement of antioxidant activity.

For ease of reference, these and further aspects of the present invention are now discussed under appropriate section headings. However, the teachings under each section are not necessarily limited to each particular section.

### Preferred Aspects

### Labiatae Extract

As discussed herein one extract used in the present invention is obtained from or is obtainable from a plant of the Labiatae family.

In one aspect the extract used in the present invention is obtained from a plant of the Labiatae family.

It will be appreciated by one skilled in the art that by the term “extract” or “extracts” it is meant any constituent of the plant which may be isolated from the whole plant.

In one aspect the extract used in the present invention is obtainable from a plant of the Labiatae family. It will be appreciated by one skilled in the art that an extract obtainable from a plant may be obtained from a plant or may be isolated from the plant, identified and then obtained from an alternative source, for example by chemical synthesis or enzymatic production. For example the extract may be produced by a eukaryotic or prokaryotic fermentation, by a process of genetic manipulation. The present applicant have recognised that products present in a plant of the Labiatae family may synergistically increase the activity of antioxidant material obtained or obtainable from a plant of the genus Matricaria or of the genus Chamaemelum. These products may be obtained from any source and will fall within the scope of the present invention.

The invention comprises use of a combination of an extract from a plant of the Labiatae family, such as rosemary (Rosmarinus officinalis) and antioxidant material obtained or obtainable from a plant of the genus Matricaria or of the genus Chamaemelum (Matricaria recurtita), that together give antioxidant activity in a food system. The extracts responsible for synergy in the present invention preferably refer to extracts of the plant family Labiatae that have been selectively extracted (“deodorised extracts”) to increase their phenolic diterpene content (such as carnosic acid). These deodorised extracts can be distinguished by their high phenolic diterpene content (for example greater than 3.5 wt. %) and their low level (less than 1 wt. %) of flavour-inducing compounds from plant essential oils and oleoresins that are used as flavours or fragrances. Essential oils are typically extracted by simple steam distillation of the plant material.

Essential oils comprise the various essential oils in plants having the odour or the flavour of the plant from which they were extracted. The essential oils are typically terpenoids often comprising monoterpenes. For example an antioxidant type of rosemary extract, which could be described as selectively extracted or deodorised, contains >3.5% wt. % phenolic diterpenes but less than 1 wt. % essential oils. A non-selective, flavouring extract contains 10-30 wt. % essential oils and a phenolic diterpene content of 2->3.5 wt. %.

An essential oil is commonly described as the volatile ethereal fraction obtained from a plant or plant part by a physical separation process such as distillation or chromatographic separation. Essential oils have also been described as a “group of odorous principles, soluble in alcohol and to a limited extent in water, consisting of a mixtures of esters, aldehydes, ketones and terpenes. Essential oils are typically obtained by distilling plants with water; the oil that separates from distillate usually has highly characteristic odors identified with the plant origin. The resulting mixture of organic compounds was thought, in the days of alchemists, to be the essence of the plant, hence the term “essential oil”.

In one preferred aspect the extract is a deodorised extract. Preferably the (deodorised) extract contains from 1.0 to 70 wt. % phenolic diterpenes, preferably 3.5 to 70 wt. % phenolic diterpenes and less than 1 wt. % essential oil. In one aspect the extract obtained from or obtainable from a plant of the Labiatae family contains phenolic diterpenes in an amount of at least 1 wt % based on the weight of extract obtained from or obtainable from a plant of the Labiatae family, such as in an amount of 1 to 95 wt % based on the weight of extract obtained from or obtainable from a plant of the Labiatae family, such as in an amount of 1 to 90 wt % based on the weight of extract obtained from or obtainable from a plant of the Labiatae family, such as in an amount of 1 to 85 wt % based on the weight of extract obtained from or obtainable from a plant of the Labiatae family, such as in an amount of 1 to 70 wt % based on the weight of extract obtained from or obtainable from a plant of the Labiatae family, such as in an amount of 1 to 50 wt % based on the weight of extract obtained from or obtainable from a plant of the Labiatae family, such as in an amount of 1 to 30 wt % based on the weight of extract obtained from or obtainable from a plant of the Labiatae family, such as in an amount of 1 to 20 wt % based on the weight of extract obtained from or obtainable from a plant of the Labiatae family, such as in an amount of 1 to 15 wt % based on the weight of extract obtained from or obtainable from a plant of the Labiatae family, such as in an amount of 1 to 10 wt % based on the weight of extract obtained from or obtainable from a plant of the Labiatae family.

In one preferred aspect the extract is or comprises a phenolic diterpene. Preferably the phenolic diterpene is carnosic acid.

In one aspect the extract obtained from or obtainable from a plant of the Labiatae family contains carnosic acid in an amount of at least 1 wt % based on the weight of extract obtained from or obtainable from a plant of the Labiatae family, such as in an amount of 1 to 95 wt % based on the weight of extract obtained from or obtainable from a plant of the Labiatae family, such as in an amount of 1 to 90 wt % based on the weight of extract obtained from or obtainable from a plant of the Labiatae family, such as in an amount of 1 to 85 wt % based on the weight of extract obtained from or obtainable from a plant of the Labiatae family, such as in an amount of 1 to 70 wt % based on the weight of extract obtained from or obtainable from a plant of the Labiatae family, such as in an amount of 1 to 50 wt % based on the weight of extract obtained from or obtainable from a plant of the Labiatae family, such as in an amount of 1 to 40 wt % based on the weight of extract obtained from or obtainable from a plant of the Labiatae family such as in an amount of 1 to 30 wt % based on the weight of extract obtained from or obtainable from a plant of the Labiatae family, such as in an amount of 1 to 25 wt % based on the weight of extract obtained from or obtainable from a plant of the Labiatae family, such as in an amount of 1 to 20 wt % based on the weight of extract obtained from or obtainable from a plant of the Labiatae family, such as in an amount of 1 to 10 wt % based on the weight of extract obtained from or obtainable from a plant of the Labiatae family, such as in an amount of 1 to 5 wt % based on the weight of extract obtained from or obtainable from a plant of the Labiatae family.

In one preferred aspect the extract contains flavour-inducing compounds and/or essential oils in an amount of less than 1 wt. % based on the extract. In one preferred aspect the extract contains flavour-inducing compounds and/or essential oils in an amount of less than 1 wt. % based on the composition.

Typically flavour-inducing compounds and/or essential oils are camphor, verbenone, borneol and alfa-terpineol.

In one preferred aspect the combined amount of camphor present in the extract is less than 1 wt. % (preferably less than 0.2 wt. %, more preferably less than 0.15 wt. %, more preferably less than 0.1 wt. %) based on the extract.

In one preferred aspect the combined amount of verbenone present in the extract is less than 1 wt. % (preferably less than 0.2 wt. %, more preferably less than 0.15 wt. %, more preferably less than 0.1 wt. %) based on the extract.

In one preferred aspect the combined amount of borneol present in the extract is less than 1 wt. % (preferably less than 0.2 wt. %, more preferably less than 0.15 wt. %, more preferably less than 0.1 wt. %) based on the extract.

In one preferred aspect the combined amount of alfa-terpineol present in the extract is less than 1 wt. % (preferably less than 0.2 wt. %, more preferably less than 0.15 wt. %, more preferably less than 0.1 wt. %) based on the extract.

In one preferred aspect the combined amount of camphor, verbenone, borneol and alfa-terpineol present in the extract is less than 1 wt. % (preferably less than 0.2 wt. %, more preferably less than 0.15 wt. %, more preferably less than 0.1 wt. %) based on the extract.

In one preferred aspect the extract contain less than 1 wt. % of plant essential oils and/or oleoresins based on the extract. In one preferred aspect the extract contain less than 1 wt. % of plant essential oils and/or oleoresins based on the composition.

In one preferred aspect the extract contains essential oils in an amount of less than 1 wt. % based on the extract. In one preferred aspect the extract contains essential oils in an amount of less than 1 wt. % based on the composition.

In one preferred aspect the plant of the Labiatae family is selected from rosemary, sage, oregano, marjoram, mint, balm, savoury and thyme. In one preferred aspect the plant of the Labiatae family is selected from rosemary, sage, oregano, marjoram, mint, balm, and savoury. It will be understood that these name cover all species and varieties of plants known by these names.

In one preferred aspect the plant of the Labiatae family is selected from rosemary (Rosmarinus officinalis L.), sage (Salvia officinalis L.) oregano (Origanum vulgare L.), marjoram (Origanum marjorana L.), mint (Mentha spp.), balm (Melissa officinalis L.), savoury (Satureia hortensis), thyme (Thymus vulgaris L.).

In one preferred aspect the plant of the Labiatae family is selected from rosemary (Rosmarinus officinalis L.), sage (Salvia officinalis L.), oregano (Origanum vulgare L.), marjoram (Origanum marjorana L.), mint (Mentha spp.), balm (Melissa officinalis L.), and savoury (Satureia hortensis).

In one preferred aspect the plant of the Labiatae family is selected from rosemary (Rosmarinus officinalis L.), sage (Salvia officinalis L.), marjoram (Origanum marjorana L.), mint (Mentha spp.), balm (Melissa officinalis L.), and savoury (Satureia hortensis).

In one preferred aspect the plant of the Labiatae family is rosemary.

In a further preferred aspect the phenolic diterpenes, phenolic triterpenes and rosmarinic acid are obtained by chemical synthesis.

Thus in highly preferred aspects the present invention provides
a foodstuff in the form of a spread, wherein the spread is a water in oil emulsion containing an anti-oxidant composition comprising (a) carnosic acid, (b) an extract obtained from or obtainable from a plant of the genus Matricaria or of the genus Chamaemelum.
a process for preventing and/or inhibiting oxidation of a foodstuff which is in the form of a spread, wherein the spread is a water in oil emulsion, the process comprising the step of contacting the spread with or incorporating in the spread (a) carnosic acid, and (b) an extract obtained from or obtainable from a plant of the genus Matricaria or of the genus Chamaemelum.
use of (a) carnosic acid, and (b) an extract obtained from or obtainable from a plant of the genus Matricaria or of the genus Chamaemelum, for preventing and/or inhibiting oxidation of a foodstuff which is in the form of a spread, wherein the spread is a water in oil emulsion

### Matricaria/Chamaemelum Extract

As discussed herein one extract used in the present invention is obtained from or is obtainable from a plant of the genus Matricaria or of the genus Chamaemelum.

Plants of the genus Matricaria and plants of the genus Chamaemelum are commonly referred to as chamomile. The term chamomile may also include plants of the genus Anthemis. Thus in one aspect the extract of a plant of the genus Matricaria or a plant of the genus Chamaemelum, may be substituted entirely or in part by a plant of the genus Anthemis. Thus in further aspects, the present invention provides
a foodstuff in the form of a spread, wherein the spread is a water in oil emulsion containing an anti-oxidant composition comprising (a) an extract obtained from or obtainable from a plant of the Labiatae family, (b) an extract obtained from or obtainable from a plant of the genus Anthemis.
a process for preventing and/or inhibiting oxidation of a foodstuff which is in the form of a spread, wherein the spread is a water in oil emulsion, the process comprising the step of contacting the spread with or incorporating in the spread (a) an extract obtained from or obtainable from a plant of the Labiatae family, (b) an extract obtained from or obtainable from a plant of the genus Anthemis.
use of (a) an extract obtained from or obtainable from a plant of the Labiatae family, (b) an extract obtained from or obtainable from a plant of the genus Anthemis for preventing and/or inhibiting oxidation of a foodstuff which is in the form of a spread, wherein the spread is a water in oil emulsion.

In one aspect the extract is obtained from or is obtainable from a plant of the genus Matricaria.

In one aspect the extract is obtained from or is obtainable from a plant of the genus Chamaemelum.

In one aspect the extract is a mixture of extract obtained from or is obtainable from a plant of the genus Matricaria and extract obtained from or is obtainable from a plant of the genus Chamaemelum.

In one aspect the extract used in the present invention is obtained from a plant of the genus Matricaria or of the genus Chamaemelum.

In one aspect the extract is obtained from a plant of the genus Matricaria.

In one aspect the extract is obtained from a plant of the genus Chamaemelum.

In one aspect extract (b) is from a plant selected from plants of the species Matricaria recurtita, Ormenis multicaulis, Eriocephalus punctulatus, Chamaemelum nobile (syn Anthemis nobilis), Anthemis arvensis, Anthemis cotula, Anthemis tinctoria and Matricaria discoidea. In one preferred aspect extract (b) is from a plant of the species Matricaria recurtita.

In one aspect the extract is a mixture of extract obtained from a plant of the genus Matricaria and extract obtained from a plant of the genus Chamaemelum.

It will be appreciated by one skilled in the art that by the term “extract” or “extracts” it is meant any constituent of the plant which may be isolated from the whole plant.

In one aspect the extract used in the present invention is obtainable from a plant of the genus Matricaria or of the genus Chamaemelum. It will be appreciated by one skilled in the art that an extract obtainable from a plant may be obtained from a plant or may be isolated from the plant, identified and then obtained from an alternative source, for example by chemical synthesis or enzymatic production. For example the extract may be produced by a eukaryotic or prokaryotic fermentation, by a process of genetic manipulation. The present applicant have recognised that products present in a plant of the genus Matricaria or of the genus Chamaemelum may synergistically increase the activity of antioxidant material obtained or obtainable from a plant of the Labiatae family. These products may be obtained from any source and will fall within the scope of the present invention.

The invention comprises use of a combination of an extract from a plant of the genus Matricaria or of the genus Chamaemelum, such as chamomile (Matricaria recurtita) and antioxidant material obtained or obtainable from a plant of the Labiatae family, that together give antioxidant activity in a food system.

In one preferred aspect the extract is or comprises a flavone. Preferably the flavone is apigenin-7-O-glucoside or a derivative thereof. Preferred derivatives of apigenin-7-β-glucoside are apigenin-7-O-(6″-malonyl-glucoside) and apigenin-7-O-(4″-acetyl-6″-malonyl-glucoside). Thus in one aspect the flavone is selected from apigenin-7-β-glucoside, apigenin-7-O-(6″-malonyl-glucoside), apigenin-7-O-(4″-acetyl-6″-malonyl-glucoside) and mixtures thereof. In one further aspect the flavone is at least apigenin-7-O-glucoside and optionally one or both of apigenin-7-O-(6″-malonyl-glucoside) and apigenin-7-O-(4″-acetyl-6″-malonyl-glucoside). In further preferred aspects the extract is or comprises
apigenin-7-O-glucoside, apigenin-7-O-(6″-malonyl-glucoside) and apigenin-7-β-(4″-acetyl-6″-malonyl-glucoside); or
apigenin-7-O-glucoside and apigenin-7-O-(6″-malonyl-glucoside); or
apigenin-7-O-glucoside and apigenin-7-O-(4″-acetyl-6″-malonyl-glucoside); or
apigenin-7-O-(6″-malonyl-glucoside) and apigenin-7-O-(4″-acetyl-6″-malonyl-glucoside); or
apigenin-7-O-glucoside; or
apigenin-7-O-(6″-malonyl-glucoside); or
apigenin-7-O-(4″-acetyl-6″-malonyl-glucoside)

In one aspect the flavone is apigenin-7-O-glucoside.

The structures of apigenin-7-O-(6″-malonyl-glucoside) and apigenin-7-O-(4″-acetyl-6″-malonyl-glucoside) are shown below

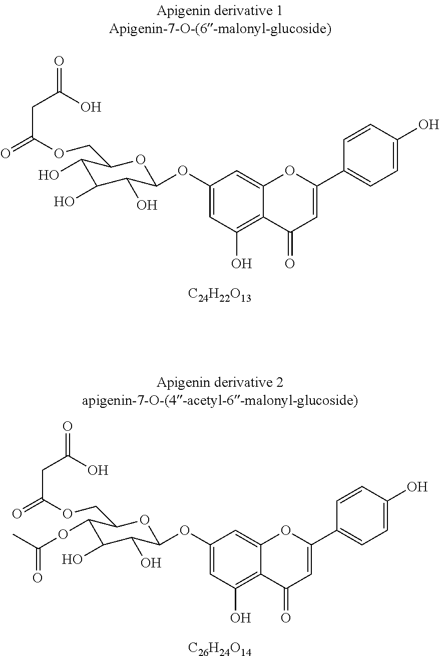

In one aspect the extract obtained from or obtainable from a plant of the Chamaemelum family contains apigenin-7-O-glucoside, apigenin-7-O-(6″-malonyl-glucoside) and apigenin-7-O-(4″-acetyl-6″-malonyl-glucoside) in an combined amount of at least 0.1 wt % based on the weight of extract obtained from or obtainable from the plant of the genus Matricaria or of the genus Chamaemelum, such as in an amount of at least 0.2 wt % based on the weight of extract obtained from or obtainable from the plant of the genus Matricaria or of the genus Chamaemelum, such as in an amount of at least 0.5 wt % based on the weight of extract obtained from or obtainable from the plant of the genus Matricaria or of the genus Chamaemelum, such as in an amount of 0.1 to 20 wt % based on the weight of extract obtained from or obtainable from the plant of the genus Matricaria or of the genus Chamaemelum, such as in an amount of 0.1 to 10 wt % based on the weight of extract obtained from or obtainable from the plant of the genus Matricaria or of the genus Chamaemelum, such as in an amount of 0.1 to 5 wt % based on the weight of extract obtained from or obtainable from the plant of the genus Matricaria or of the genus Chamaemelum, such as in an amount of 0.2 to 3 wt % based on the weight of extract obtained from or obtainable from the plant of the genus Matricaria or of the genus Chamaemelum, such as in an amount of 0.2 to 2 wt % based on the weight of extract obtained from or obtainable from the plant of the genus Matricaria or of the genus Chamaemelum, such as in an amount of 0.5 to 2 wt % based on the weight of extract obtained from or obtainable from the plant of the genus Matricaria or of the genus Chamaemelum. It will be understood by one skilled in the art that one or more of apigenin-7-O-glucoside, apigenin-7-O-(6″-malonyl-glucoside) and apigenin-7-O-(4″-acetyl-6″-malonyl-glucoside) may not be present provided the combined total amounts of apigenin-7-O-glucoside, apigenin-7-O-(6″-malonyl-glucoside) and apigenin-7-O-(4″-acetyl-6″-malonyl-glucoside) which are present is within the recited range.

In one aspect the extract obtained from or obtainable from a plant of the Chamaemelum family contains apigenin-7-O-glucoside in an amount of at least 0.1 wt % based on the weight of extract obtained from or obtainable from the plant of the genus Matricaria or of the genus Chamaemelum, such as in an amount of at least 0.2 wt % based on the weight of extract obtained from or obtainable from the plant of the genus Matricaria or of the genus Chamaemelum, such as in an amount of at least 0.5 wt % based on the weight of extract obtained from or obtainable from the plant of the genus Matricaria or of the genus Chamaemelum, such as in an amount of 0.1 to 20 wt % based on the weight of extract obtained from or obtainable from the plant of the genus Matricaria or of the genus Chamaemelum, such as in an amount of 0.1 to 10 wt % based on the weight of extract obtained from or obtainable from the plant of the genus Matricaria or of the genus Chamaemelum, such as in an amount of 0.1 to 5 wt % based on the weight of extract obtained from or obtainable from the plant of the genus Matricaria or of the genus Chamaemelum, such as in an amount of 0.2 to 3 wt % based on the weight of extract obtained from or obtainable from the plant of the genus Matricaria or of the genus Chamaemelum, such as in an amount of 0.2 to 2 wt % based on the weight of extract obtained from or obtainable from the plant of the genus Matricaria or of the genus Chamaemelum, such as in an amount of 0.5 to 2 wt % based on the weight of extract obtained from or obtainable from the plant of the genus Matricaria or of the genus Chamaemelum.

In one preferred aspect the plant of the genus Matricaria or of the genus Chamaemelum is chamomile. It will be understood that these name cover all species and varieties of plants known by these names. In one preferred aspect the plant of the genus Matricaria or of the genus Chamaemelum is a plant of the species Matricaria recurtita. It is noted that this species may also be known as Matricaria chamomilla.

In a further preferred aspect the apigenin-7-O-glucoside is obtained by chemical synthesis.

Thus in highly preferred aspects the present invention provides
a foodstuff in the form of a spread, wherein the spread is a water in oil emulsion containing an anti-oxidant composition comprising (a) an extract obtained from or obtainable from a plant of the Labiatae family, (b) a flavone selected from apigenin-7-O-glucoside, derivatives thereof and combinations thereof (wherein the derivatives thereof are preferably selected from apigenin-7-O-(6″-malonyl-glucoside) and apigenin-7-O-(4″-acetyl-6″-malonyl-glucoside).
a process for preventing and/or inhibiting oxidation of a foodstuff which is in the form of a spread, wherein the spread is a water in oil emulsion, the process comprising the step of contacting the spread with or incorporating in the spread (a) an extract obtained from or obtainable from a plant of the Labiatae family, and (b) a flavone selected from apigenin-7-O-glucoside, derivatives thereof and combinations thereof (wherein the derivatives thereof are preferably selected to from apigenin-7-O-(6″-malonyl-glucoside) and apigenin-7-O-(4″-acetyl-6″-malonyl-glucoside)
use of (a) an extract obtained from or obtainable from a plant of the Labiatae family, and (b) a flavone selected from apigenin-7-O-glucoside, derivatives thereof and combinations thereof (wherein the derivatives thereof are preferably selected from apigenin-7-O-(6″-malonyl-glucoside) and apigenin-7-O-(4″-acetyl-6″-malonyl-glucoside), for preventing and/or inhibiting oxidation of a foodstuff which is in the form of a spread, wherein the spread is a water in oil emulsion.
a foodstuff in the form of a spread, wherein the spread is a water in oil emulsion containing an anti-oxidant composition comprising (a) an extract obtained from or obtainable from a plant of the Labiatae family, (b) apigenin-7-O-glucoside.
a process for preventing and/or inhibiting oxidation of a foodstuff which is in the form of a spread, wherein the spread is a water in oil emulsion, the process comprising the step of contacting the spread with or incorporating in the spread (a) an extract obtained from or obtainable from a plant of the Labiatae family, and (b) apigenin-7-O-glucoside.
use of (a) an extract obtained from or obtainable from a plant of the Labiatae family, and (b) apigenin-7-O-glucoside for preventing and/or inhibiting oxidation of a foodstuff which is in the form of a spread, wherein the spread is a water in oil emulsion

### Composition

It will be understood that the components of the anti-oxidant composition utilised in the present invention may be present in any amount to provide an antioxidant effect and in particular (a) extract obtained from or obtainable from a plant of the Labiatae family and (b) extract obtained from or obtainable from a plant of the genus Matricaria or of the genus Chamaemelum, are present in amounts to provide a enhanced anti-oxidant effect.

In one aspect the ratio of (a) extract obtained from or obtainable from a plant of the Labiatae family, to (b) extract obtained from or obtainable from a plant of the genus Matricaria or of the genus Chamaemelum, is from 30:1 to 1:20, such as 30:1 to 1:1, such as 20:1 to 1:20, such as 20:1 to 1:1, such as 15:1 to 1:20, such as 15:1 to 1:1, such as 10:1 to 1:20, such as 10:1 to 1:1, such as 5:1 to 1:20, such as 5:1 to 1:1., such as 1:1 to 1:15, such as 1:1 to 1:10, such as 1:1 to 1:5, such as 1:1 to 1:2, such as approximately 1:1.

In one aspect the ratio of (a) active anti-oxidant ingredient obtained from or obtainable from a plant of the Labiatae family, to (b) active anti-oxidant ingredient obtained from or obtainable from a plant of the genus Matricaria or of the genus Chamaemelum, is from 85:1 to 1:10, such as 85:1 to 1:5, such as 85:1 to 1:2, such as 85:1 to 1:1, such as 85:1 to 2:1, such as 85:1 to 5:1, such as 85:1 to 10:1, such as 85:1 to 15:1, such as 85:1 to 20:1, such as 70:1 to 1:1, such as 60:1 to 1:1, such as 50:1 to 1:1, such as 40:1 to 1:1, such as 30:1 to 1:1, such as 25:1 to 1:1, such as 20:1 to 1:1. In one aspect the ratio of (a) active anti-oxidant ingredient obtained from or obtainable from a plant of the Labiatae family, to (b) active anti-oxidant ingredient obtained from or obtainable from a plant of the genus Matricaria or of the genus Chamaemelum, is from 15:1 to 1:1, such as 10:1 to 1:1, such as 70:1 to 10:1, such as 60:1 to 10:1, such as 50:1 to 10:1, such as 40:1 to 10:1, such as 30:1 to 10:1, such as 25:1 to 15:1. In one aspect the ratio of (a) active anti-oxidant ingredient obtained from or obtainable from a plant of the Labiatae family, to (b) active anti-oxidant ingredient obtained from or obtainable from a plant of the genus Matricaria or of the genus Chamaemelum, is from 15:1 to 1:1, such as 15:1 to 2:1, such as 15:1 to 5:1, such as 15:1 to 10:1, such as 14:1 to 11:1, such as 13:1 to 11:1.

In one aspect the ratio of (a) phenolic diterpene, to (b) flavone, is from 85:1 to 1:10, such as 85:1 to 1:5, such as 85:1 to 1:2, such as 85:1 to 1:1, such as 85:1 to 2:1, such as 85:1 to 5:1, such as 85:1 to 10:1, such as 85:1 to 15:1, such as 85:1 to 20:1, such as 70:1 to 1:1, such as 60:1 to 1:1, such as 50:1 to 1:1, such as 40:1 to 1:1, such as 30:1 to 1:1, such as 25:1 to 1:1, such as 20:1 to 1:1. In one aspect the ratio of (a) phenolic diterpene, to (b) flavone, is from 15:1 to 1:1, such as 10:1 to 1:1, such as 70:1 to 10:1, such as 60:1 to 10:1, such as 50:1 to 10:1, such as 40:1 to 10:1, such as 30:1 to 10:1, such as 25:1 to 15:1 In one aspect the ratio of (a) phenolic diterpene, to (b) flavone, is from 15:1 to 1:1, such as 15:1 to 2:1, such as 15:1 to 5:1, such as 15:1 to 10:1, such as 14:1 to 11:1, such as 13:1 to 11:1.

In one aspect the ratio of (a) carnosic acid, to (b) apigenin-7-O-glucoside, is from 85:1 to 1:10, such as 85:1 to 1:5, such as 85:1 to 1:2, such as 85:1 to 1:1, such as 85:1 to 2:1, such as 85:1 to 5:1, such as 85:1 to 10:1, such as 85:1 to 15:1, such as 85:1 to 20:1, such as 70:1 to 1:1, such as 60:1 to 1:1, such as 50:1 to 1:1, such as 40:1 to 1:1. In one aspect the ratio of (a) carnosic acid, to (b) apigenin-7-O-glucoside, is from 30:1 to 1:1, such as 25:1 to 1:1, such as 20:1 to 1:1, such as 15:1 to 1:1, such as 10:1 to 1:1, such as 70:1 to 10:1, such as 60:1 to 10:1, such as 50:1 to 10:1, such as 40:1 to 10:1, such as 30:1 to 10:1, such as 25:1 to 15:1. In one aspect the ratio of (a) carnosic acid, to (b) apigenin-7-O-glucoside, is from 40:1 to 1:1, such as 40:1 to 5:1, such as 40:1 to 10:1, such as 40:1 to 15:1, such as 40:1 to 20:1, such as 40:1 to 25:1, such as 40:1 to 30:1, such as 35:1 to 30:1.

### Spread

The composition, process and use of the present invention may prevent and/or inhibit oxidation in a spread suitable for use as a foodstuff. It is understood by one skilled in the art that such a spread is a water in oil emulsion. It will be appreciated by one skilled in the art that the essential components of (a) an extract obtained from or obtainable from a plant of the Labiatae family and (b) extract from a plant of the genus Matricaria or of the genus Chamaemelum may have been provided by one or more means. For example they may have been added in the form of a composition containing the extracts. The components may have been added to the spread sequentially.

The spread is formed from oil and water in a water in oil emulsion. By oil it is meant both solid and liquid fats. Oil referred to herein means triglycerides of fatty acids. The spread may contain any suitable amount of triglycerides of fatty acids to provide a spread having acceptable properties. In one aspect, the spread contains triglycerides of fatty acids in amount of less than 80 wt % based on the total spread. In one aspect, the spread contains triglycerides of fatty acids in amount of from 15 to 80 wt % based on the total spread. In one aspect, the spread contains triglycerides of fatty acids in amount of from 30 to 80 wt % based on the total spread. In one aspect, the spread contains triglycerides of fatty acids in amount of from 40 to 80 wt % based on the total spread. In one aspect, the spread contains triglycerides of fatty acids in amount of from 50 to 70 wt % based on the total spread. In one aspect, the spread contains triglycerides of fatty acids in amount of approximately 60 wt % based on the total spread.

In one aspect the spread may be a low fat spread. Thus in one aspect, the spread contains triglycerides of fatty acids in amount of less than 50 wt % based on the total spread. In one aspect, the spread contains triglycerides of fatty acids in amount of less than 41 wt % based on the total spread. In one aspect, the spread contains triglycerides of fatty acids in amount of less than 40 wt % based on the total spread.

In one aspect the present composition is dosed in a spread in an amount to provide the extract obtained from or obtainable from a plant of the genus Labiatae in an amount of no greater than 5000 ppm based on the weight of the spread, such as no greater than 4000 ppm, such as no greater than 3000 ppm, such as no greater than 2000 ppm, such as no greater than 1000 ppm, such as no greater than 700 ppm, such as no greater than 500 ppm, such as no greater than 400 ppm, such as no greater than 300 ppm such as no greater than 200 ppm, such as no greater than 150 ppm, such as no greater than 100 ppm, such as no greater than 75 ppm, such as no greater than 50 ppm, such as no greater than 40 ppm, such as 1 to 150 ppm, such as 1 to 100 ppm, such as 1 to 50 ppm, such as 1 to 40 ppm, such as 10 to 150 ppm, such as 10 to 100 ppm, such as 10 to 70 ppm, such as 10 to 50 ppm, such as 20 to 50 ppm based on the weight of the spread.

In one aspect the present composition is dosed in a spread in an amount to provide the extract obtained from or obtainable from a plant of the genus Matricaria or of the genus Chamaemelum in an amount of no greater than 5000 ppm based on the weight of the spread, such as no greater than 4000 ppm, such as no greater than 3000 ppm, such as no greater than 2000 ppm, such as no greater than 1000 ppm, such as no greater than 700 ppm, such as no greater than 500 ppm, such as no greater than 400 ppm, such as no greater than 300 ppm based on the weight of the spread, such as no greater than 200 ppm, such as no greater than 150 ppm, such as no greater than 100 ppm, such as no greater than 75 ppm, such as no greater than 50 ppm, such as no greater than 40 ppm, such as 1 to 150 ppm, such as 1 to 100 ppm, such as 1 to 50 ppm, such as 1 to 40 ppm, such as 10 to 150 ppm, such as 10 to 100 ppm, such as 20 to 100 ppm, such as 10 to 50 ppm, such as 20 to 50 ppm based on the weight of the spread.

In one aspect the present composition is dosed in a spread in an amount to provide active anti-oxidant ingredient obtained from or obtainable from a plant of the genus Labiatae in an amount of no greater than 1000 ppm based on the weight of the spread, such as no greater than 700 ppm, such as no greater than 500 ppm, such as no greater than 400 ppm, such as no greater than 200 ppm based on the weight of the spread, such as no greater than 150 ppm, such as no greater than 100 ppm, such as no greater than 75 ppm, such as no greater than 50 ppm, such as no greater than 40 ppm, such as 1 to 100 ppm, such as 1 to 75 ppm, such as 1 to 50 ppm, such as 1 to 40 ppm, such as 10 to 100 ppm, such as 10 to 75 ppm, such as 10 to 50 ppm, such as 20 to 50 ppm based on the weight of the spread.

In one aspect the present composition is dosed in a spread in an amount to provide active anti-oxidant ingredient obtained from or obtainable from a plant of the genus Matricaria or of the genus Chamaemelum in an amount of no greater than 5000 ppm such as no greater than 4000 ppm, such as no greater than 3000 ppm, such as no greater than 2000 ppm such as no greater than 1000 ppm, such as no greater than 700 ppm, such as no greater than 500 ppm, such as no greater than 400 ppm, such as no greater than 200 ppm, such as no greater than 100 ppm, such as no greater than 75 ppm, such as no greater than 50 ppm, such as no greater than 40 ppm, such as no greater than 20 ppm based on the weight of the spread, such as no greater than 15 ppm, such as no greater than 10 ppm, such as no greater than 7 ppm, such as no greater than 5 ppm, such as no greater than 4 ppm, such as 1 to 10 ppm, such as 1 to 7 ppm, such as 1 to 5 ppm, such as 1 to 4 ppm, such as 2 to 5 ppm, such as 0.1 to 10 ppm, such as 0.1 to 7 ppm, such as 0.1 to 5 ppm, such as 0.1 to 4 ppm, such as 0.5 to 5 ppm, such as 0.5 to 4 ppm, such as 0.8 to 5 ppm, such as 0.8 to 4 ppm.

In one aspect the present composition is dosed in a spread in an amount to provide phenolic diterpene obtained from or obtainable from a plant of the genus Labiatae in an amount of no greater than 1000 ppm based on the weight of the spread, such as no greater than 700 ppm, such as no greater than 500 ppm, such as no greater than 400 ppm, such as no greater than 200 ppm based on the weight of the spread, such as no greater than 150 ppm, such as no greater than 100 ppm, such as no greater than 75 ppm, such as no greater than 50 ppm, such as no greater than 40 ppm, such as 1 to 100 ppm, such as 1 to 75 ppm, such as 1 to 50 ppm, such as 1 to 40 ppm, such as 10 to 100 ppm, such as 10 to 75 ppm, such as 10 to 50 ppm, such as 20 to 50 ppm based on the weight of the spread.

In one aspect the present composition is dosed in a spread in an amount to provide flavone obtained from or obtainable from a plant of the genus Matricaria or of the genus Chamaemelum in an amount of no greater than 5000 ppm such as no greater than 4000 ppm, such as no greater than 3000 ppm, such as no greater than 2000 ppm such as no greater than 1000 ppm, such as no greater than 700 ppm, such as no greater than 500 ppm, such as no greater than 400 ppm, such as no greater than 200 ppm, such as no greater than 100 ppm, such as no greater than 75 ppm, such as no greater than 50 ppm, such as no greater than 40 ppm, such as no greater than 20 ppm based on the weight of the spread, such as no greater than 15 ppm, such as no greater than 10 ppm, such as no greater than 7 ppm, such as no greater than 5 ppm, such as no greater than 4 ppm, such as 1 to 10 ppm, such as 1 to 7 ppm, such as 1 to 5 ppm, such as 1 to 4 ppm, such as 2 to 5 ppm such as 0.1 to 10 ppm, such as 0.1 to 7 ppm, such as 0.1 to 5 ppm based on the weight of the spread, such as 0.1 to 4 ppm, such as 0.5 to 5 ppm, such as 0.5 to 4 ppm, such as 0.8 to 5 ppm, such as 0.8 to 4 ppm.

In one aspect the present composition is dosed in a spread in an amount to provide carnosic acid in an amount of no greater than 500 ppm, such as no greater than 400 ppm, such as no greater than 200 ppm, such as no greater than 100 ppm, such as no greater than 75 ppm, such as no greater than 50 ppm, such as no greater than 40 ppm, such as no greater than 200 ppm based on the weight of the spread, such as no greater than 150 ppm, such as no greater than 100 ppm, such as no greater than 75 ppm, such as no greater than 50 ppm, such as no greater than 40 ppm, such as 1 to 100 ppm, such as 1 to 75 ppm, such as 1 to 50 ppm, such as 1 to 40 ppm, such as 10 to 100 ppm, such as 10 to 75 ppm, such as 10 to 50 ppm, such as 20 to 50 ppm based on the weight of the spread.

In one aspect the present composition is dosed in a spread in an amount to provide apigenin-7-O-glucoside in an amount of no greater than 2000 ppm such as no greater than 1000 ppm, such as no greater than 500 ppm, such as no greater than 400 ppm, such as no greater than 200 ppm, such as no greater than 100 ppm, such as no greater than 75 ppm, such as no greater than 50 ppm, such as no greater than 40 ppm, such as no greater than 20 ppm based on the weight of the spread, such as no greater than 15 ppm, such as no greater than 10 ppm, such as no greater than 7 ppm, such as no greater than 5 ppm, such as no greater than 4 ppm, such as 1 to 10 ppm, such as 1 to 7 ppm, such as 1 to 5 ppm, such as 2 to 5 ppm such as 0.01 to 10 ppm, such as 0.01 to 7 ppm, such as 0.01 to 5 ppm based on the weight of the spread.

The spread of the present invention may contain edible fats and/or oils, or mixtures thereof whose origin is vegetable or animal fats or any form of oil from marine species. Vegetable oils may be, for example, soybean oil, canola oil, corn oil, sunflower oil, safflower oil or olive oil. Lard and tallow can be blended mostly in low-cost products. In Europe, use of palm oil, lauric fats and hydrogenated marine oils is common. Non-hydrogenated oils may typically represent the majority of the fat phase. Lesser amounts of partially hydrogenated stocks, fats that are naturally semisolid at room temperature and/or hard fractions of certain fats and/or interesterified oils can be added to the blend as required to deliver the desired structure and melting properties. They may also contain small amounts of other lipids such as phospholipids, unsaponifiable matter, and free fatty acids naturally present in the fat or oil.

The aqueous phase may contain one or more of the following Ingredients):

(1) Water and/or Milk and/or Milk Products: Cultured milk, skim milk
(2) Edible Proteins: whey (liquid, condensed, or dry form), whey modified by the reduction of lactose and/or minerals, nonlactose containing whey components, albumin, casein, caseinate, vegetable proteins, soy protein isolate

Other optional ingredients include:

### (1) Vitamin A, D, E and K

(2) Salt (sodium chloride); potassium chloride for dietary margarine and fat spreads
(3) Nutritive carbohydrate sweetners
(4) Emulsifiers: lecithin, monoglycerides
(5) Preservatives: Preservatives including but not limited to the following: Sorbic acid, benzoic acid and their sodium, potassium and calcium salts; Calcium disodium EDTA; Propyl, octyl, and dodecyl gallates; BHA, BHT, ascorbyl palmitate, ascorbyl stearate, stearyl citrate, isopropyl citrate mixture
(6) Colour additives: Beta-carotene, annatto extract, turmeric extract
(7) Flavoring substances

### (8) Acidulants

### (9) Alkalizers

(10) Thickeners: alginate, pectin, xanthan

### Additional Components

The composition of the present invention or the composition for use in the present invention may contain one or more additional components. However, in some aspects the antioxidant composition of the present invention (suitable for addition to a foodstuff) contains no additional components or contains no additional components that materially to affect the properties of the composition. In these aspects the present invention provides
a foodstuff in the form of a spread, wherein the spread is a water in oil emulsion containing an anti-oxidant composition consisting essentially of (a) an extract obtained from or obtainable from a plant of the Labiatae family, (b) an extract obtained from or obtainable from a plant of the genus Matricaria or of the genus Chamaemelum.
a process for preventing and/or inhibiting oxidation of a foodstuff which is in the form of a spread, wherein the spread is a water in oil emulsion, the process comprising the step of contacting the spread with or incorporating in the spread with a composition consisting essentially of (a) an extract obtained from or obtainable from a plant of the Labiatae family, and (b) an extract obtained from or obtainable from a plant of the genus Matricaria or of the genus Chamaemelum.
use of a composition consisting essentially of (a) an extract obtained from or obtainable from a plant of the Labiatae family, and (b) an extract obtained from or obtainable from a plant of the genus Matricaria or of the genus Chamaemelum, for preventing and/or inhibiting oxidation of a foodstuff which is in the form of a spread, wherein the spread is a water in oil emulsion

In one preferred aspect the spread further comprises (c) an extract obtained from or obtainable from a plant of the Cynara family. In one preferred aspect the composition further comprises (c) an extract obtained from a plant of the Cynara family. Preferably the plant of the Cynara family is selected from an artichoke. Preferably the plant of the Cynara family is selected from Cynara scolymus and Cynara cardunculus. Preferably the plant of the Cynara family is Cynara scolymus.

In one preferred aspect the composition further comprises a carrier. Preferably the carrier is selected from propylene glycol, maltodextrin, sugar, salt, ethanol, water, protein, glycerol, medium chain triglyceride (MCT oil), and vegetable oil.

In one preferred aspect the composition further comprises an emulsifier. Preferably the emulsifier is selected from polyoxyethylene sorbitan esters (polysorbates), polyoxyethylene stearate, mono- and diglycerides of fatty acids, mono- and diglycerides esters further esterified with a dibasic organic acid selected from acetic acid, lactic acid, citric acid and mono- and diacetyl tartaric acid or mixtures thereof, lecithin, polyglycerol esters of fatty acids, polyglycerol polyricinoleate, sucrose esters of fatty acids, sucroglycerides, propylene glycol esters of fatty acids, sorbitan esters of fatty acids, sodium and calcium salt of stearoyl-2-lactylate, sodium, potassium, calcium and magnesium salts of fatty acids and ammonium phosphatides.

### Process

As discussed herein in one aspect the present invention provides a process for preventing and/or inhibiting oxidation of a foodstuff which is in the form of a spread, wherein the spread is a water in oil emulsion, the process comprising the step of contacting the spread with or incorporating in the spread (a) an extract obtained from or obtainable from a plant of the Labiatae family, and (b) an extract obtained from or obtainable from a plant of the genus Matricaria or of the genus Chamaemelum.

In one aspect the extract obtained from or obtainable from a plant of the Labiatae family, and the extract obtained from or obtainable from a plant of the genus Matricaria or of the genus Chamaemelum are added to the spread together.

In one aspect the extract obtained from or obtainable from a plant of the Labiatae family, and the extract obtained from or obtainable from a plant of the genus Matricaria or of the genus Chamaemelum are added to the spread sequentially.

### Further Aspects

In a further aspect the present invention provides an alternative foodstuff. Thus in a further aspect the present invention provides a foodstuff in the form of a dressing, wherein the dressing is an oil in water emulsion containing an anti-oxidant composition comprising
(a) an extract obtained from or obtainable from a plant of the Labiatae family,
(b) an extract obtained from or obtainable from a plant of the genus Matricaria or of the genus Chamaemelum.

In one aspect the present invention provides a process for preventing and/or inhibiting oxidation of a foodstuff in the form of a dressing, wherein the dressing is an oil in water emulsion, the process comprising the step of contacting the spread with or incorporating in the dressing
(a) an extract obtained from or obtainable from a plant of the Labiatae family, and
(b) an extract obtained from or obtainable from a plant of the genus Matricaria or of the genus Chamaemelum.

In one aspect the present invention provides use of
(a) an extract obtained from or obtainable from a plant of the Labiatae family, and
(b) an extract obtained from or obtainable from a plant of the genus Matricaria or of the genus Chamaemelum,
   for preventing and/or inhibiting oxidation of a foodstuff in the form of a dressing, wherein the dressing is an oil in water emulsion containing oil in an amount of less than 60 wt % based on the total dressing. Preferably the oil in water emulsion contains oil in an amount of from 30 wt % to less than 60 wt % based on the total dressing.

The dressing may be a salad dressing, also known as a ranch dressing. The dressing may optionally contain vinegar(s), lemon juice or lime juice. However, no minimum acetic acid or citric acid levels are required. The dressing may optionally contain egg-yolk solids in a minimum amount of 4 wt % based on the dressing. The dressing may optionally contain starch, such as a food starch or modified food starch; tapioca flour, wheat flour, rye flour, or a combination thereof. The dressing may optionally contain optional ingredients selected from salt, nutritive carbohydrate sweeteners, spices or natural flavorings, monosodium glutamate, dioctyl sodium sulfosuccinate, citric and/or malic acid, sequestrants, and crystallization inhibitors. A salad dressing may be as defined by the CFR (21 CFR 169.150), that is: “The emulsified semisolid food prepared from vegetable oil(s), acidifying ingredients as specified, egg yolk-containing ingredients as specified, and a starch paste as specified”.

The present invention will now be described in further detail by way of example only with reference to the accompanying figures in which:—

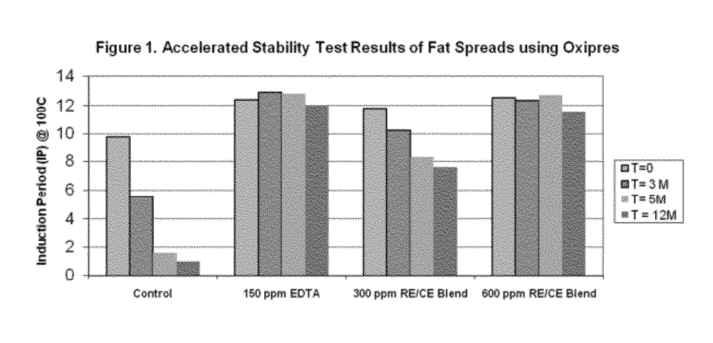

FIG. 1 shows a graph;

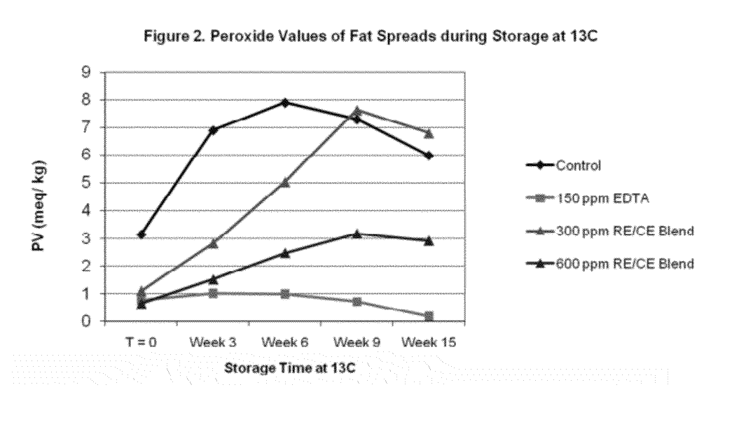

FIG. 2 shows a graph;

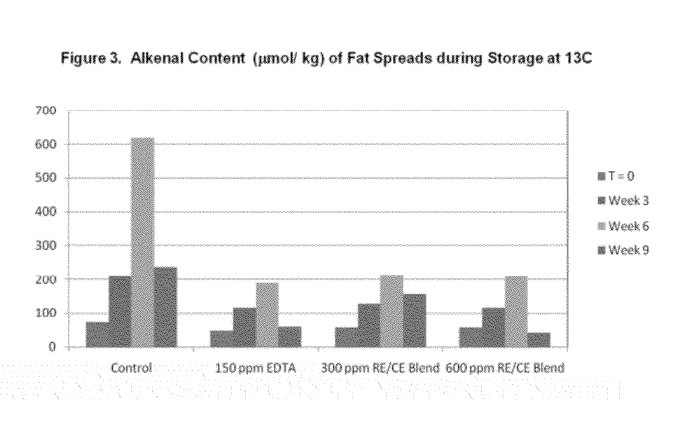

FIG. 3 shows a graph;

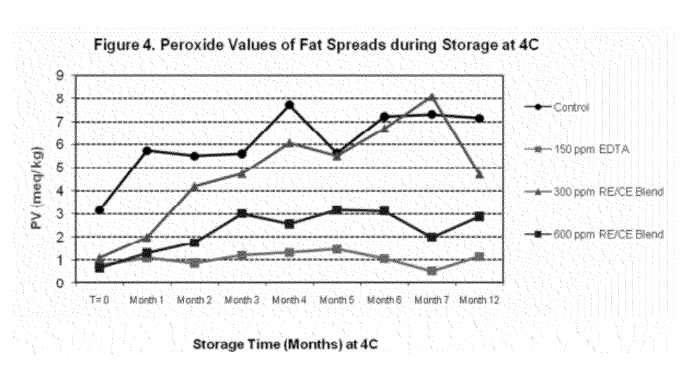

FIG. 4 shows a graph;

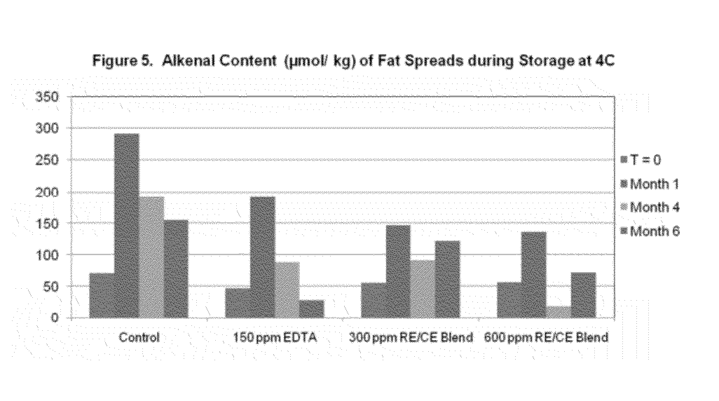

FIG. 5 shows a graph;

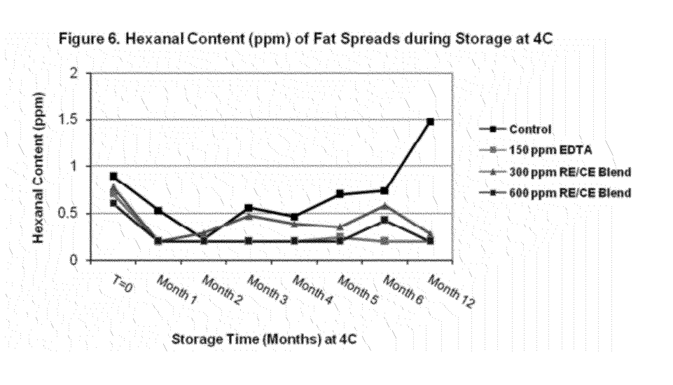

FIG. 6 shows a graph;

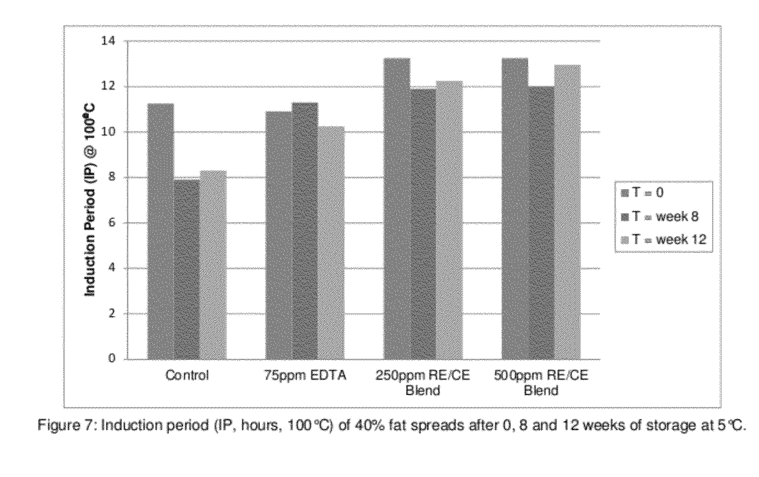

FIG. 7 shows a graph;

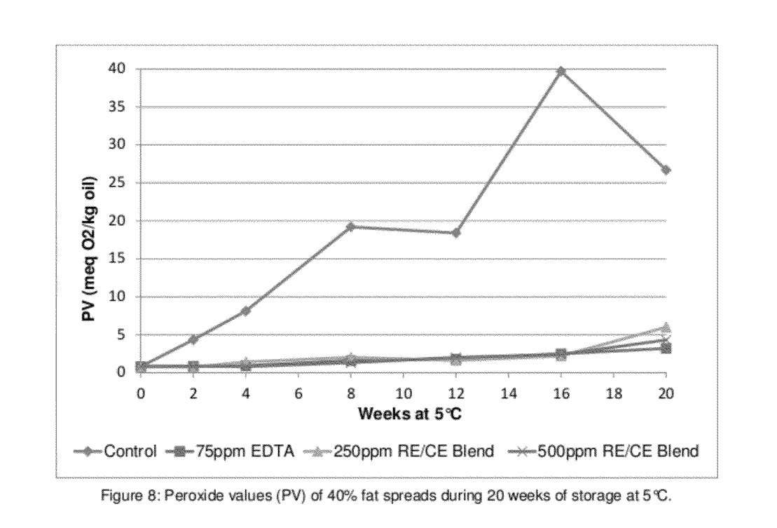

FIG. 8 shows a graph;

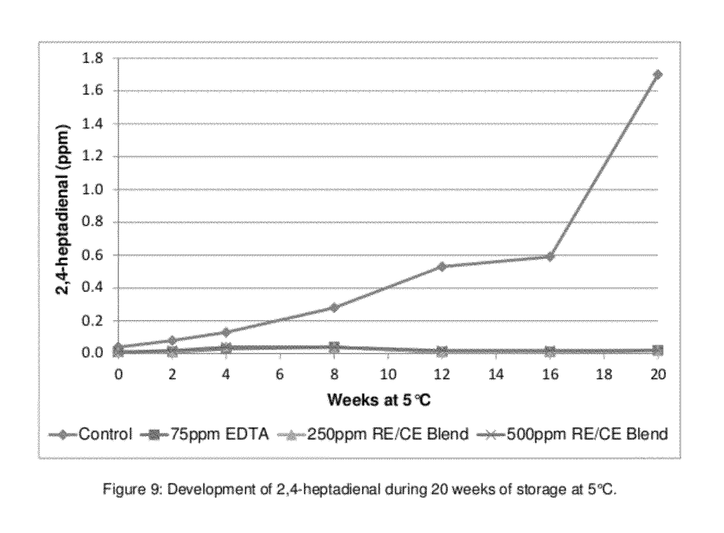

FIG. 9 shows a graph; and

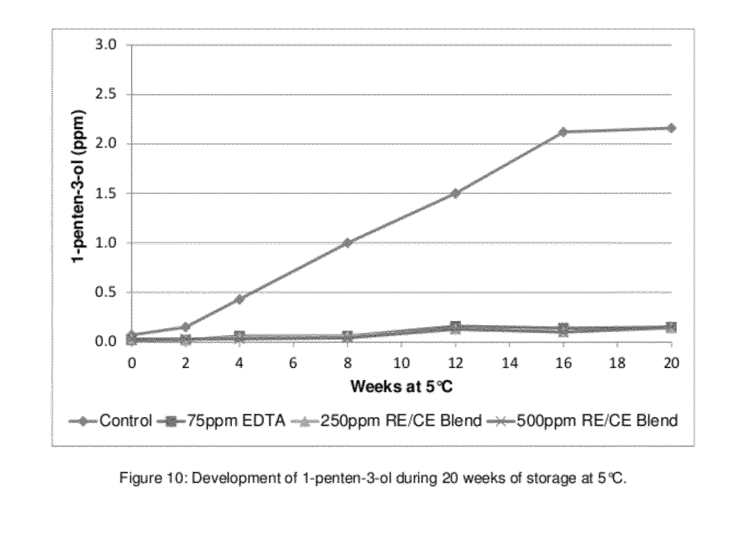

FIG. 10 shows a graph.

The present invention will now be described in further detail in the following examples.

### EXAMPLES

### Antioxidants Used

The rosemary extract (RE) and chamomile extract (CE) blend used in the Examples was a mixture of hydroalcoholic extracts from rosemary (Rosmarinus officinalis L.) and chamomile (Matricaria recurita) dissolved in propylene glycol. The content of phenolic diterpenes (which includes carnosic acid) was approximately 4 wt % and the content of flavones (which includes apigenin-7-O-glucoside, apigenin-7-O-(6″-malonyl-glucoside) and apigenin-7-O-(4″-acetyl-6″-malonyl-glucoside) was approximately 0.33 wt %. The blend is referred to as ‘RE/CE blend’ and is available from Danisco A/S, Denmark.

### Example 1-60% Fat Spreads

Five 20-kg batches of 60% fat spreads were produced. Spreads were prepared on a pilot-scale Gerstenberg SchrOder unit. Oil components (Soy oil blend and emulsifier) were tempered in a jacketed kettle with scrape surface mixing until a temperature of 60° C. was reached. Once oil phase has stabilized at desired temperature, beta carotene, flavour and lecithin were added. The aqueous phase was prepared by mixing whey powder, salt, sodium benzoate and potassium sorbate in water. The aqueous phase, heated to 50° C., was slowly added to oil phase with constant agitation. Following mixing, spread ingredients were pumped into crystallizer #1 with a swept surface heat exchanger (SSHE) turning 800 rpm at 23-25° C. Spread then proceeded to crystallizer #2 with a SSHE turning 800 rpm at 17-18° C. and finally passed through a pin roller at 400 rpm. Samples were collected in 16-oz tubs. Fat spreads were produced using the formula given in Table 1. Different samples were then stored at 4° C. and 13° C., and their properties evaluated regularly.

TABLE 1
Formula for 60% fat spreads

| | | Fat spread | Fat spread | Fat spread | Fat spread |
|---|---|---|---|---|---|
| | | containing | containing | containing | containing |
| | Fat spread without | 150-ppm | 600-ppm | 1200-ppm | 300-ppm |
| | antioxidants | EDTA | RE/CE | RE/CE | RE/CE |
| Soy oil blend | 11873.60 | 11873.60 | 11873.60 | 11873.60 | 11873.60 |
| DIMODAN ® S^{c} | 80.00 | 80.00 | 80.00 | 80.00 | 80.00 |
| Flavour | 6.00 | 6.00 | 6.00 | 6.00 | 6.00 |
| Betacarotene | 0.40 | 0.40 | 0.40 | 0.40 | 0.40 |
| Lecithin | 40.00 | 40.00 | 40.00 | 40.00 | 40.00 |
| Water | 7460.00 | 7457.00 | 7448.00 | 7436.00 | 7454.00 |
| Salt | 300.00 | 300.00 | 300.00 | 300.00 | 300.00 |
| Whey powder | 200.00 | 200.00 | 200.00 | 200.00 | 200.00 |
| Sodium benzoate | 20.00 | 20.00 | 20.00 | 20.00 | 20.00 |
| Potassium sorbate | 20.00 | 20.00 | 20.00 | 20.00 | 20.00 |
| EDTA^{b} | | 3.00 | | | |
| RE/CE blend | | | 12.00 | 24.00 | 6.00 |
| TOTAL (g) | 20000.00 | 20000.00 | 20000.00 | 20000.00 | 20000.00 |

Soy oil blend is composed of 55% liquid soybean oil and 45% partially hydrogenated soybean oil.
^{b}EDTA - Food grade disodium EDTA (Versene ™ NA) was from Dow Chemical Company (Michigan, USA)
^{c}DIMODAN ® S is composed of distilled monoglyceride made from edible, partially hydrogenated soybean oil and was from Danisco A/S, Denmark

### Antioxidants Tested

Control (with nothing added)
EDTA—150 ppm (w/w of fat spread)
RE/CE blend—300 ppm (w/w, of fat spread) (eq. to 12 ppm phenolic diterpenes and 1 ppm flavones)—to provide chamomile extract in an amount of 24.8 ppm in the fat spread and to provide rosemary extract in an amount of 16.5 ppm in the fat spread.
RE/CE blend—600 ppm (w/w, of fat spread) (eq. to 24 ppm phenolic diterpenes and 2 ppm flavones) to provide chamomile extract in an amount of 49.5 ppm in the fat spread and to provide rosemary extract in an amount of 33 ppm in the fat spread.
RE/CE blend—1200 ppm (w/w, of fat spread) (eq. to 48 ppm phenolic diterpenes and 4 ppm flavones) to provide chamomile extract in an amount of 99 ppm in the fat spread and to provide rosemary extract in an amount of 66 ppm in the fat spread.

### Procedure

### Measurement of Colour

Minolta colorimeter (CM-700d; Konica Minolta Sensing, Inc., Japan) was used for colour measurements. Lightness (L* value), redness (a* value), and yellowness (b* value) were measured.

### Determination of Peroxide Value Using SafTest

The peroxide value (PV) determination using PeroxySafe™ STD kit (SafTest, Inc.) was carried out. The procedures adopted followed the manufacturer's recommendations.

### Determination of Alkenal Content Using Saftest

The alkenal value determination using AlkalSafe™ STD kit (SafTest, Inc.) was carried out. The procedures adopted followed the manufacturer's recommendations.

### Evaluation of Oxidative Stability Using OXIPRES™ Method

The stability against oxidation was determined using the ML OXIPRES™ (manufactured by Mikrolab, Aarhus, Denmark). The samples were placed in closed containers with an oxygen headspace. Oxidation was accelerated by heating the samples and by the use of oxygen under pressure. Oxidation of the product is detected by a drop of pressure within the closed container. This pressure drop was measured electronically. The Induction Period (IP) was calculated as the time after which the pressure began to decrease abruptly (its end-point was measured from the cross-section point of tangents of the first part and the subsequent part of the curve recording the pressure changes). The reaction conditions were as follows: 25 g samples; initial pressure 5.0 bar; temperature 100° C.

Determination of Hexanal Content Using Gas Chromatography with Flame Ionization Detection (GC-FID)

Hexanal content was determined using Gas chromatography with flame ionization detection (GC-FID). A homogenous portion of the sample was mixed with water containing an internal standard. It was heated in a heating block for a specified amount of time, after which a sample of the headspace over the mixture is taken and injected into the gas chromatograph. The hexanal released into the headspace was quantitated via comparison of the hexanal gas's chromatographic response to that of the internal standard.

### Sensory Evaluation

The products were evaluated by a group of 8 panelists. Using a difference from control method, panelists were asked to compare the control sample to fortified samples. They were asked to use a 7 point scale where 0 is no difference and 6 is large difference. They were instructed to allow the samples to be in the mouth for about 30 seconds, and asked to rinse and expectorate between samples to eliminate sample carry over and fatigue.

### Results and Discussion

### Characteristics of Soybean Oil Blend

Initial quality characteristics of soybean oil blend used for production of 60% fat spreads are reported in Table 2. The PV of the oil blend was below detection limit. The low iodine value of the product indicates high stability. The major fatty acids of the oil blend were oleic (18:1), stearic (18:0) and palmitic (16:0) acids. Lipid class profile indicates that majority of the lipids is in the triglyceride (TAG) form.

TABLE 2
Composition of the Soybean oil blend used for production of 60% fat
spreads

| Parameter | Results |
|---|---|
| Peroxide Value (meq/kg) | Below detection |
| Iodine Value | 96.1 |
| Fatty Acid Profile: | % |
| C 14:0 | 0.07 |
| C 15:0 | 0.04 |
| C16:0 | 10.7 |
| C16:1 | 0.1 |
| C18:0 | 9.6 |
| C18:1 | 48.3 |
| C18:3 | 3.1 |
| C20:0 | 0.4 |
| C20:1 | 0.2 |
| C22:0 | 0.4 |
| C24:0 | 0.1 |
| Lipid class profile: | |
| Triglycerides (TAGs) | 97.6 |
| Diglycerides (DAGs) | 1.99 |
| Monoglycerides (MAGs) | 0.3 |
| Free Fatty Acids (FFAs) | 0.0 |

### Sensory Evaluation of 60% Fat Spreads

Using a difference from control method, panelists were asked to compare the control sample to fortified samples. They were asked to use a 7 point scale where 0 is no difference and 6 is large difference. They were instructed to allow the samples to be in the mouth for about 30 seconds, and asked to rinse and expectorate between samples to eliminate sample carry over and fatigue. Sensory evaluation data are presented in Table 3.

Panelists could not detect a difference (p≦0.05) between the control (with nothing added) and the EDTA-treated sample.

Panelists could not detect a difference (p≦0.05) between the control (with nothing added) and the RE/CE blend-treated sample at 300 ppm.

Panelists could not detect a difference (p≦0.05) between the control (with nothing added) and the RE/CE blend-treated sample at 600 ppm.

Panelists detected a significant difference (p≧0.05) between the control (with nothing added) and the RE/CE blend-treated sample at 1200 ppm.

Based on the sensory evaluation results, the appropriate usage level of RE/CE blend for this application would be in the range of 300 to 600 ppm.

TABLE 3
Sensory scores

| Sample | N | Sensory scores (mean ± SD) |
|---|---|---|
| Blind control | 8 | 0.78 ± 0.7^{a} |
| EDTA | 8 | 1.38 ± 1.8^{a} |
| 0.03% RE/CE blend | 8 | 2.25 ± 1.8^{a} |
| 0.06% RE/CE blend | 8 | 1.50 ± 1.7^{a} |
| 0.12% RE/CE blend | 8 | 3.63 ± 1.3^{b} |

Means in the column with the same letter are not significantly different at p ≦ 0.05

### Colour of Fat Spreads

The colour measurements of the products were carried out immediately after the production. Instrumental colour L* value (lightness), a* value (redness), and b* value (yellowness) of samples are shown in Table 4.

TABLE 4
Instrumental colour values (L*, a*, b*) of fat spreads

| Sample | L* Value | a* Value | b* Value |
|---|---|---|---|
| Control | 90.2 ± 2.1^{a} | 5.4 ± 0.4^{a} | 26.7 ± 1.3^{a} |
| EDTA | 87.7 ± 5.8^{a} | 5.1 ± 0.3^{a} | 23.3 ± 3.1^{a} |
| 0.03% RE/CE blend | 87.4 ± 1.2^{a} | 8.7 ± 0.4^{a} | 36.7 ± 3.8^{a} |
| 0.06% RE/CE blend | 84.5 ± 4.0^{a} | 7.2 ± 0.3^{a} | 29.4 ± 1.1^{a} |
| 0.12% RE/CE blend | 84.2 ± 4.3^{a} | 6.5 ± 0.3^{a} | 29.3 ± 1.8^{a} |

Means in columns with the same letter are not significantly different at p ≦ 0.1

### Accelerated Shelf-life Testing of 60% Fat Spreads

Samples of 60% fat spreads were produced with 300 ppm, and 600 ppm RE/CE blend or 150 ppm of EDTA and stored at 4° C. for 12 months. A control sample contained no antioxidant solution. In an accelerated shelf-life test, a comparison of 600-ppm RE/CE blend and EDTA reveals somewhat similar performance (FIG. 1). In addition, oxidative stability of RE/CE blend at all usage levels was significantly higher than that of the control sample containing no antioxidants.

### Accelerated Shelf-life Testing of 60% Fat Spreads

Samples of 60% fat spreads were stored at 13° C. for 15 weeks. Peroxide values (PV) of samples during storage are shown in FIG. 2. An increase in PV (primary oxidation products) during storage indicates an oxidation of samples. The EDTA-sample had the lowest PV during storage. Among the RE/CE blend-supplemented samples, 600-ppm sample had the lowest PVs during storage. Overall, control sample had the highest PV throughout storage.

Alkenal contents of samples during storage are shown in FIG. 3. The alkenal contents of RE/CE blend-supplemented samples were similar to EDTA-treated sample. Among the samples tested, the control sample had the highest content of secondary oxidation products (alkenals).

### Shelf-life Testing of 60% Fat Spreads

Samples of 60% fat spreads were stored at 4° C. for 12 months. Peroxide values (PV) of samples during storage at 4° C. are shown in FIG. 4. The EDTA-sample had the lowest PV during storage. Among the RE/CE blend-supplemented samples, 600-ppm sample had the lowest PVs during storage. In addition, the PV's of the RE/CE blend at 600-ppm were significantly lower than those of the control sample containing no antioxidants.

Alkenal contents of samples during storage at 4° C. are shown in FIG. 5. The alkenal contents of RE/CE blend-supplemented samples were somewhat similar to EDTA-treated sample. Among the samples tested, the control sample had the highest content of secondary oxidation products (alkenals).

Hexanal contents of samples during storage at 4° C. are shown in FIG. 6. The performance of RE/CE blend at 600 ppm was similar to that of the EDTA-treated sample.

### CONCLUSION

This study has shown efficient antioxidant activity of natural chelator (chamomile and rosemary extract blend) in 60% fat spreads. Sensory evaluation results indicated that RE/CE blend at 300-600 ppm did not cause any flavour impact (p 0.05) on the final product. Based on the accelerated shelf-life testing (OXIPRES™), oxidative stability of RE/CE blend at 600-ppm was comparable to that of the EDTA-supplemented product. Peroxide values (a measure of primary oxidation products), alkenal values and hexanal content (measures secondary oxidation products) of RE/CE blend-supplemented sample at 600 ppm were lower than those of the control sample throughout storage.

Food manufacturers are currently looking for clean label ingredients with efficient chelating activity to substitute EDTA in food emulsions. In regard to the results of this work, natural extract blend of chamomile and rosemary extract is recommended as a substitute for EDTA to maintain the quality and improve the shelf-life of the margarines and spreads.

### Example 2

### 40% Fat Spreads

Four 6 kg batches of 40% fat spreads were produced. Spreads were made on a pilot-scale Gerstenberg SchrOder unit. Fat phase (rapeseed oil, hardstock, emulsifier and betacarotene) were heated to 80° C. in water bath and mixed well. The fat phase was then tempered to 50° C. in water bath. Water phase was prepared by mixing salt, skimmed milk powder, potassium sorbate and EDTA or RE/CE blend. Water phase were tempered to 50° C. in water bath and was slowly added to the fat phase with constant agitation. Emulsion were then pumped (high pressure pump speed 30 kg/h) into crystallizer #1, a scraped surface heat exchanger (SSHE) at 1000 rpm (outlet temp. approx. 11° C.) and proceeded into crystallizer #2 (SSHE) at 1000 rpm (outlet temp. approx. 12° C.).

Samples were collected in 400 mL food-approved plastic containers (RingSafe®, RPC Superfos, Denmark) Fat spreads were produced using the formula given in Table 5. Samples were then stored at 5° C. and their properties evaluated regularly 20 weeks of storage.

TABLE 5
Formula for 40% Fat Spreads

| | | | Fat spread | |
|---|---|---|---|---|
| | | Fat spread | containing | Fat spread |
| | Fat spread | containing | 250-ppm | containing 500- |
| | without | 75-ppm | RE/CE | ppm RE/CE |
| | antioxidants | EDTA | blend | blend |
| ^{a}Rapeseed oil | 2368.80 | 2368.80 | 2368.80 | 2368.80 |
| blend | | | | |
| ^{b}DIMODAN ® | 30.00 | 30.00 | 30.00 | 30.00 |
| U/J-K | | | | |
| Betacarotene | 1.20 | 1.20 | 1.20 | 1.20 |
| (2% solution) | | | | |
| Water | 3540.00 | 3539.55 | 3538.50 | 3537.00 |
| Salt | 48.00 | 48.00 | 48.00 | 48.00 |
| Skimmed milk | 6.00 | 6.00 | 6.00 | 6.00 |
| powder (MILEX | | | | |
| 240) | | | | |
| Potassium | 6.00 | 6.00 | 6.00 | 6.00 |
| sorbate | | | | |
| Calcium di- | 0.00 | 0.45 | 0.00 | 0.00 |
| sodium EDTA | | | | |
| RE/CE blend | 0.00 | 0.00 | 1.50 | 3.00 |
| TOTAL (g) | 6000.00 | 6000.00 | 6000.00 | 6000.00 |

^{a}Rapeseed Oil Blend is composed of 75% rapeseed oil and 25% interesterified blend.
^{b}DIMUDAN ® U/J-K is distilled monoglyceride made from edible, refined sunflower oil and was from Danisco A/S, Denmark

### Antioxidants Tested

Control (with nothing added)
EDTA—75 ppm (w/w of fat spread). Food Grade EDTA calcium disodium salt (Art. no.: 161710136340) was from Kirsch Pharma GmbH, Salzgitter, Germany.
RE/CE blend—250 ppm (w/w, of fat spread) (eq. to 10 ppm phenolic diterpenes and 0.8 ppm flavones)—to provide chamomile extract in an amount of 20.6 ppm in the fat spread and to provide rosemary extract in an amount of 13.8 ppm in the fat spread.
RE/CE blend—500 ppm (w/w, of fat spread) (eq. to 20 ppm phenolic diterpenes and 1.7 ppm flavones)—to provide chamomile extract in an amount of 41.3 ppm in the fat spread and to provide rosemary extract in an amount of 27.5 ppm in the fat spread.

### Procedure

### Determination of Metals in Fat Spreads

The content of Cu, Fe, Ni and Zn was measured in triplicates by Inductively Coupled Plasma-Optical Emission Spectroscopy (ICP-OES) using a Varian Vista MPX (Varian, Palo Alto, Calif.). The analysis of elements was done according to the Official Methods of Analysis of the AOAC International, 16^{th} Edition, Methods: 965.09, 977,29, 985,01, 984,27.

### Evaluation of Oxidative Stability of 40% Fat Spreads Using OXIPRES™ Method

The stability against oxidation was determined using the ML OXIPRES™ (manufactured by Mikrolab, Aarhus, Denmark). The samples were placed in closed containers with an oxygen headspace. Oxidation was accelerated by heating the samples and by the use of oxygen under pressure. As the oil oxidized, the oxygen content of the headspace gas decreased which resulted in a drop of pressure within the closed container. This pressure drop was measured electronically. The Induction Period (IP) was calculated as the time after which the pressure began to decrease abruptly (its end-point was measured from the cross-section point of tangents of the first part and the subsequent part of the curve recording the pressure changes). The reaction conditions were as follows: 20 g samples; initial pressure 5.0 bar; temperature 100° C.

### Sensory Evaluation of Fat Spreads

The products were evaluated by a small panel of 4-6 judges. The major interest was to evaluate effects of the antioxidants on the perception of rancidity in products during storage. Further the panel was instructed in evaluating potential extract off-taste and/or colour defects in fortified samples. Additional observations, such as sample acidity and/or bland taste were further noticed.

### Determination of Peroxide Value of Fat Spreads

The peroxide value (PV) of fat spreads were determined in duplicates after 0, 2, 4, 8, 12, 16 and 20 days of storage at 5° C. by potentiometric titration according to: The American Oil Chemists' Society: Official Methods and Recommended Practices of The AOCS, 5^{th} Edition, Method: Cd 8-53.

Determination of Volatiles in the Separated Oil Phase by Gas Chromatography-mass Spectrometry with Selected Ion Monitoring (GC-MS-SIM)

The content of 2,4-heptadienal and 1-penten-3-ol was determined using Gas chromatography-mass spectrometry with selected ion monitoring (GC-MS-SIM). 2 g (+/−0.1 g) of separated oil phase (emulsion separated by freezing, thawing and centrifugation) was weighed into 22 mL vials and added internal standard (5-methyl-2-hexanone) corresponding to 1 mg/kg. Subsequently, the volatiles were extracted from the gas phase for 20 minutes at 50° C. using the Solid Phase Micro Extraction principle (SPME). The volatiles were then thermo desorbed in the hot injection port of a GC/MS system, and a chromatogram was acquired. The GC/MS is run in SIM-mode (Selected Ion Monitoring), where only selected components are detected. The content of 2,4-heptadienal and 1-penten-3-ol was quantified after 0, 2, 4, 8, 12, 16 and 20 days of storage at 5° C. via comparison of the volatiles response to that of the internal standard.

### Results and Discussion

### Determination of Metals in Fat Spreads

The content of Cu, Fe, Ni and Zn in freshly produced 40% fat spreads is presented in Table 6. The content of Mg was slightly higher than typical theoretical levels found according to Saxholt & Møller (2003), www.foodcomp.dk, Danish Food Composition, “Margarine 40% fat, vegetable fat”.

TABLE 6
Content of metals (mg/kg) in 40% fat spreads.

| | Measured level | Theoretical level |
|---|---|---|
| Metal | (ppm) | (ppm) |
| Cu | 0.2 | <0.25 |
| Fe | <0.1 | 0.4-1.3 |
| Mg | 24 | 2-4 |
| Ni | <0.1 | 0.03 |

### Evaluation of Oxidative Stability of 40% Fat Spreads Using OXIPRES™ Method

The induction period of 40% fat spreads was monitored by OXIPRES™ method (100° C.) after 0, 8 and 12 weeks of storage at 5° C. RE/CE blend-supplemented samples all appeared to have a better oxidative stability (increased IP) than the unprotected control sample, but also the EDTA-sample (FIG. 7).

### Sensory Evaluation of Fat Spreads

Fat spreads were evaluated by a small panel of 4-6 judges. The most relevant observations of the sensory evaluation after 0, 2, 8, 12 and 20 weeks of storage at 5° C. are summarized in Table 7.

An oxidized note was rapidly detected in the unprotected control sample (showing signs of oxidation already after 2 weeks and becoming rancid after 8 weeks storage). On the contrary, fat spreads supplemented with RE/CE blend and EDTA appeared oxidative stabile throughout 20 weeks of storage. The EDTA supplemented sample was described having an acidic, bland and/or off-taste note throughout the evaluation period by some of the judges. None of the judges described colour issues of adding RE/CE blend at 250-500 ppm and only once an extract note was detected (after week 8 where two out of five judges detected extract note).

TABLE 7
Sensory evaluation of fat spreads after 0, 2, 8, 12 and 20 weeks of storage
at 5° C. (n = number of judges on the given day).

| | Week 0 | Week 2 | Week 8 | Week 12 | Week 20 |
|---|---|---|---|---|---|
| Treatment | (n = 6) | (n = 5) | (n = 4) | (n = 6) | (n = 6) |
| Control | Ok | (Ok) | Rancid | Rancid | Rancid |
| | | 2 out of 5 | | | |
| | | detects off- | | | |
| | | taste | | | |
| 75 ppm EDTA | Ok | Ok | Ok | Ok | Ok |
| | | 4 out of 5 | 3 out of 4 | 6 out of 6 | |
| | | detects | detects | detects | |
| | | bland note | bland/acid | bland/chemical/ | |
| | | | note | off-taste | |
| 250 ppm | Ok | Ok | Ok | Ok | Ok |
| RE/CE blend | | | | | |
| 500 ppm | Ok | Ok | Ok | Ok | Ok |
| RE/CE blend | | | 2 out of 4 | 3 out of 6 | |
| | | | detect | found sample | |
| | | | extract note | best | |

### Determination of Peroxide Value of Fat Spreads

Samples of 40% fat spreads were stored at 5° C. for 20 weeks. Peroxide values (PV) of samples during storage are shown in FIG. 8. An increase in PV indicates primary oxidation of samples. The control sample had the highest PV throughout storage. The RE/CE blend supplemented samples demonstrated comparable antioxidant protection to EDTA until week 16.

Determination of Volatiles in the Separated Oil Phase by Gas Chromatography-mass Spectrometry with Selected Ion Monitoring (GC-MS-SIM)

Oxidation of polyunsaturated fatty acid (PUFA) oils produces a complex mixture of volatile secondary oxidation products. In the fat spreads, 2,4-heptadienal and 1-penten-3-ol were chosen as markers for secondary oxidation in the product. The content of both oxidation products increased rapidly in the unprotected control sample and was suppressed in supplemented samples throughout the 20 weeks storage period at 5° C. as shown in FIGS. 9 and 10. The antioxidant protection of the RE/CE blend was comparable to EDTA.

### CONCLUSION

This current study demonstrates efficient antioxidant activity of natural chelator (chamomile and rosemary extract blend) in 40% fat spreads. Based on accelerated shelf-life testing (OXIPRES™), sensory evaluation, inhibition of peroxides and volatile oxidation products (2-4-heptadienal and 1-penten-3-ol) during 20 weeks of storage at 5° C. an antioxidant protection comparable to 75 ppm EDTA was demonstrated by adding 250-500 ppm RE/CE blend to the spread.

Food manufacturers are currently looking for clean label ingredients with efficient chelating activity to substitute EDTA in food emulsions. In regard to the results of this work, natural extract blend of chamomile and rosemary extract is recommended as a substitute for EDTA to maintain the quality and improve the shelf-life of the margarines and spreads.

### Example 3

### Ranch Dressing

Ranch dressing samples were prepared from the ingredients listed in Table 8. First, a dry blend was prepared by mixing Grindsted® CFF 1212 with sugar. This dry blend was then added into water under agitation and mixed at 500-1000 rpm for 3-5 minutes. Mixing was done using the IKA Laboratory Mixer (IKA Lobortechnik; IKA Works, Malaysia). Next, partial amount of non-fat dry milk was added and mixed at 500-1000 rpm for additional 5-10 minutes. Subsequently, egg yolk powder, rest of the non-fat dry milk, mustard flour, Nisaplin®, MicroGARD® 100 and antioxidants were added. Next, soybean oil was slowly added into the mixture followed by the addition of garlic, onion powder and salt. These ingredients were then mixed at 500-1000 rpm for 5-10 minutes. Subsequently, lactic acid, lemon juice and vinegar were added. Once the crude emulsion was made, Silverson Laboratory mixer (Model L4R; Silverson Machines Ltd., Waterside, England) was used for hard shearing (10,000 rpm for 5-10 minutes). Next, herbs (parsley flakes, dill weed, and dry basil) and black pepper were added and mixed gently for 5-10 minutes. The final product was then transferred to air tight containers and stored.

Antioxidant Treatments used were:

(a) RE/CE blend—800 ppm (eq. to 32 ppm phenolic diterpenes and 2.6 ppm flavones) to provide chamomile extract in an amount of 66 ppm in the ranch dressing and to provide rosemary extract in an amount of 44 ppm in the ranch dressing.
(b) RE/CE blend—1000 ppm (eq. to 40 ppm phenolic diterpenes and 3.3 ppm flavones) to provide chamomile extract in an amount of 82.5 ppm in the ranch dressing and to provide rosemary extract in an amount of 55 ppm in the ranch dressing.
(c) EDTA—75 ppm; and
(d) Control with no antioxidant.

GRINDSTED® CFF 1212 is a food-grade blend of modified guar gum and xanthan gum available from Danisco A/S, Denmark.

Nisaplin® is a product containing nisin available from Danisco NS, Denmark.

MicroGARD® 100 is a bioprotectant consisting of fermentation metabolites of starter cultures (cultured grade A non-fat dry milk powder and grade A non-fat dry milk powder). available from Danisco A/S, Denmark.

TABLE 8
Composition of ranch dressing

| | | | | Ranch |
|---|---|---|---|---|
| | | Ranch | | dressing |
| | Ranch | dressing | Ranch dressing | containing |
| | dressing | containing | containing 800- | 1000-ppm |
| | with no | 75-ppm | ppm RE/CE | RE/CE |
| | antioxidants | EDTA | blend | blend |
| Soybean oil | 600.0 | 600.0 | 600.0 | 600.0 |
| Egg yolk powder | 33.0 | 33.0 | 33.0 | 33.0 |
| Sugar | 13.5 | 13.5 | 13.5 | 13.5 |
| Salt | 15.0 | 15.0 | 15.0 | 15.0 |
| Water | 656.7 | 656.6 | 655.5 | 655.2 |
| Non fat dry milk | 48.8 | 48.8 | 48.8 | 48.8 |
| Lemon juice | 4.5 | 4.5 | 4.5 | 4.5 |
| Lactic acid | 1.8 | 1.8 | 1.8 | 1.8 |
| Vinegar (50 | 97.5 | 97.5 | 97.5 | 97.5 |
| grain) | | | | |
| Mustard flour | 4.5 | 4.5 | 4.5 | 4.5 |
| Onion powder | 7.5 | 7.5 | 7.5 | 7.5 |
| Garlic powder | 3.8 | 3.8 | 3.8 | 3.8 |
| Black pepper | 0.9 | 0.9 | 0.9 | 0.9 |
| Parsley flakes | 3.0 | 3.0 | 3.0 | 3.0 |
| Dill weed | 0.3 | 0.3 | 0.3 | 0.3 |
| Basil, dry | 0.3 | 0.3 | 0.3 | 0.3 |
| Nisaplin ® | 0.75 | 0.75 | 0.75 | 0.75 |
| GRINDSTED ® | 5.25 | 5.25 | 5.25 | 5.25 |
| CFF 1212 | | | | |
| MicroGARD ® | 3.0 | 3.0 | 3.0 | 3.0 |
| 100 | | | | |
| EDTA^{a} | — | 0.11 | — | — |
| RE/CE blend | — | — | 1.2 | 1.5 |
| TOTAL (g) | 1500 | 1500 | 1500 | 1500 |

^{a}Food Grade Disodium EDTA (Versene ™ NA) from Dow Chemical Company (Michigan, USA)

### pH Measurements of Ranch Dressing

The pH measurements of the samples were taken immediately after production. Results are reported in Table 9. All of the samples had very similar pH values.

TABLE 9
pH Values of ranch dressing

| Ranch Dressing Sample | pH |
|---|---|
| Control (no antioxidants) | 4.23 |
| EDTA-75 ppm | 4.28 |
| RE/CE blend-800 ppm | 4.27 |
| RE/CE blend-1000 ppm | 4.14 |

### Sensory Evaluation of Ranch Dressing

Panelists were asked to compare the EDTA supplemented sample to the rest of the samples. They were asked to use a 7 point scale of 0 to 6, where 0 is no difference and 6 is large difference. They were instructed to allow the samples to be in the mouth for about 30 seconds, and asked to rinse and expectorate between samples to eliminate sample carry over and fatigue. Sensory evaluation data are presented in Table 10. Among the samples evaluated, no significant sensory differences were noted between samples. In addition, no off-flavours were detected in any of the fresh and aged samples.

Panelists could not detect a difference (p≦0.05) between the ranch dressing with EDTA and the RE/CE blend sample at 800 ppm.

Panelists could not detect a difference (p≦0.05) between the ranch dressing with EDTA and the RE/CE blend sample at 1000 ppm.

Panelists could not detect a difference (p≦0.05) between the ranch dressing with EDTA and the ranch dressing with no antioxidant.

TABLE 10
Sensory stability data

| | | T = 0 | | T = 6M |
|---|---|---|---|---|
| Sample | N | (Mean ± SD) | N | (Mean ± SD) |
| EDTA-75 ppm | 9 | 1.67 ± 1.0^{a} | 7 | 3.43 ± 2.4^{a} |
| RE/CE blend-800 ppm | 9 | 1.86 ± 2.5^{a} | 7 | 3.71 ± 2.5^{a} |
| RE/CE blend-1000 ppm | 9 | 1.71 ± 1.3^{a} | 7 | 3.00 ± 1.9^{a} |
| Control (no antioxidant) | 9 | 2.14 ± 2.3^{a} | 7 | 3.29 ± 2.2^{a} |

Means in the column with the same letter are not significantly different at p ≦ 0.05

### Colour Measurements of Ranch Dressing

The colour measurements of the products were carried out immediately after the production. Minolta colorimeter (CM-700d; Konica Minolta Sensing, Inc., Japan) was used for colour measurements. Instrumental colour L* value (lightness) and b* value (yellowness) of samples are shown in Table 11. The colour values of all the samples are not significantly different from one another. These results indicate that RE/CE blend did not impact the colour of the final product.

TABLE 11
Instrumental colour values (L* and b*) of ranch dressing samples

| Sample | L* Value | b* Value |
|---|---|---|
| Control (no antioxidant) | 86.6 ± 0.8^{a} | 10.8 ± 0.6^{a} |
| EDTA-75 ppm | 86.9 ± 1.4^{a} | 11.3 ± 1.1^{a} |
| RE/CE blend-800 ppm | 86.2 ± 1.3^{a} | 11.0 ± 0.6^{a} |
| RE/CE blend-1000 ppm | 86.7 ± 0.6^{a} | 11.2 ± 0.3^{a} |

Means in columns with the same letter are not significantly different at p ≦ 0.05

### Accelerated Shelf-life Testing of Ranch Dressing: CHECKMATE Results

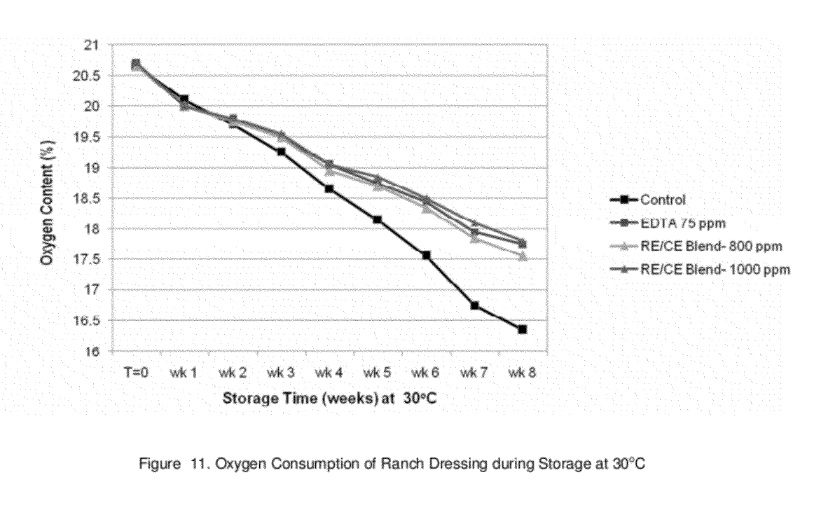

Oxygen Consumption of ranch dressing during storage at 30° C. was measured using the CheckMate II oxygen analyzer (PBI-Dansensor America Inc., Glen Rock, N.J.), and results are shown in FIG. 11. Among the samples tested, control sample with no antioxidant had consumed higher amount of oxygen than the antioxidant-treated samples. EDTA and RE/CE blend-supplemented samples were more stable than the control sample with no antioxidant. Based on the oxygen consumption data, the performance of RE/CE blend samples is very similar to that of the EDTA sample.

### Accelerated Shelf-life Testing of Ranch Dressing: OXIPRES™ Results

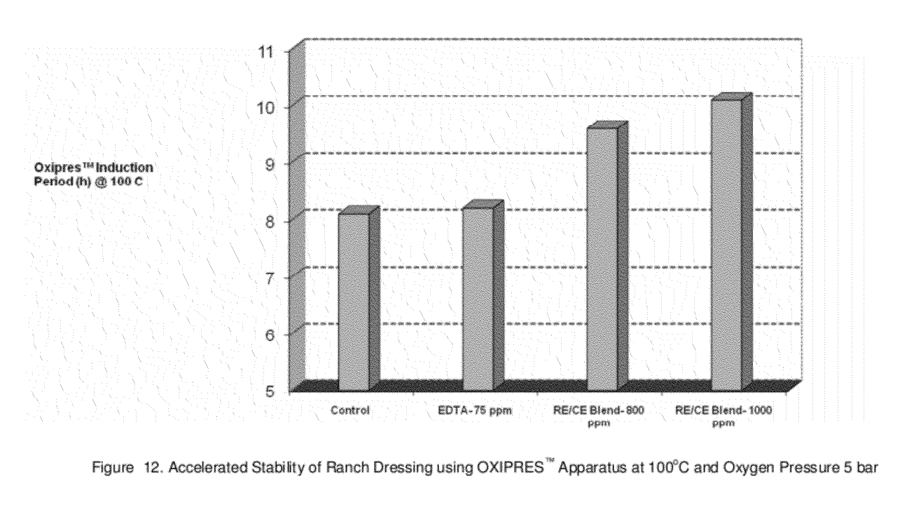

Accelerated stability of ranch dressing was evaluated using the OXIPRES™ (manufactured by Mikrolab, Aarhus, Denmark) method. The induction periods (IPs) were determined from pressure decrease in the OXIPRES™ as a result of oxygen consumption. The high IP value is an indication of high oxidative stability. The EDTA sample (at 75 ppm) and the control (no antioxidant) had low IPs, whereas RE/CE blend-supplemented samples had high IPs (FIG. 12). Moreover, based on the OXIPRES™ data, the performance of EDTA sample is very similar to that of the control sample (no antioxidant). The IP of RE/CE blend at 1000 ppm was higher than the IP value of the same product at 800 ppm.

### Room Temperature Testing of Ranch Dressing: Peroxide Values

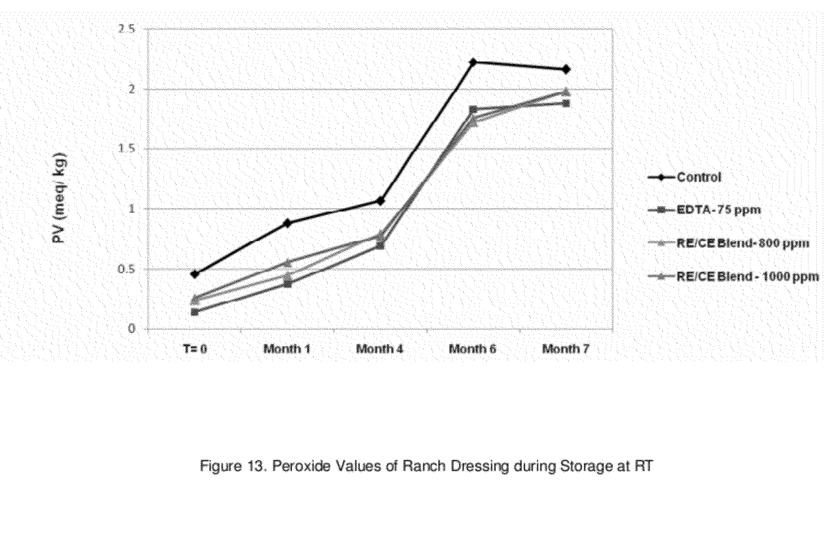

Ranch dressing samples were stored at 25° C. for 7 months. Peroxide values (PV) of samples during storage are shown in FIG. 13. PeroxySafe™ STD kit (SafTest, Inc.) was used for PV measurements. An increase in PV (primary oxidation products) during storage indicates an oxidation of samples. Among the samples tested, control sample with no antioxidant had developed higher amount of hydroperoxides during storage. EDTA and RE/CE blend-supplemented samples had lower amount of PVs. Based on the PV data, the performance of RE/CE blend is very similar to that of the EDTA sample.

### Room Temperature Testing of Ranch Dressing: Hexanal Contents

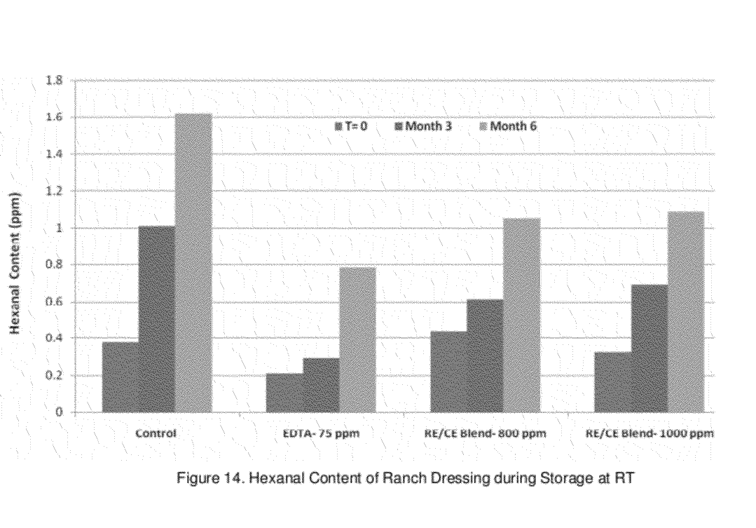

Hexanal contents (a measure of secondary oxidation products of lipids) of ranch dressing samples during storage at 25° C. are shown in FIG. 14. Hexanal content was determined using Gas chromatography with flame ionization detection (GC-FID). Control sample had higher content of hexanal formed during the 6-month storage period. EDTA and RE/CE blend-supplemented samples had lower content of hexanal compared to the control.

### CONCLUSION

This current study demonstrates efficient antioxidant activity of natural chelator (chamomile and rosemary extract blend) in ranch dressing. Sensory evaluation results indicated that RE/CE blend at 800-1000 ppm did not cause any flavour impact (p 0.05) on the final product. Based on accelerated shelf-life testing (OXIPRES™), monitoring oxygen consumption and inhibition of peroxides and volatile oxidation product (hexanal) an antioxidant protection comparable to 75 ppm EDTA was demonstrated by adding 800-1000 ppm RE/CE blend to the ranch dressing.

Food manufacturers are currently looking for clean label ingredients with efficient chelating activity to substitute EDTA in food emulsions. In regard to the results of this work, natural extract blend of chamomile and rosemary extract is recommended as a substitute for EDTA to maintain the quality and improve the shelf-life of ranch dressing.

### REFERENCES

1. Langsrud, ø. (2002). 50-50 multivariate analysis of variance for collinear responses. The Statistician 51(3), pp. 305-317
2. Langsrud ø. (2000), Fifty-Fifty MANOVA: Multivariate Analysis of Variance for Collinear Responses, Proceedings of The Industrial Statistics in Action 2000, vol. 2, pp. 250-264
3. Let, M. B., Jacobsen, C. & Meyer, A. S. (2004). Effects of fish oil type lipid antioxidants and presence of rapeseed oil on oxidative flavour stability of fish oil enriched milk. European Journal of Lipid Science and Technology, 106, pp. 170-182
4. Hartvigsen, K., Lund, P., Hansen, L. F. & Holmer, G. (2000). Dynamic headspace of volatiles produced in fish oil enriched mayonnaise during storage. Journal of Agricultural and Food Chemistry, 48, pp. 4858-4867
5. Thorsen, M. A., & Hildebrandt, K. S. (2003). Quantitative determination of phenolic diterpenes in rosemary extracts: Aspects of accurate quantification. Journal of Chromatography A, 995, pp. 119-125.
6. Nychas, G.-J. E., Skandamis, P. N. 2003. Antimicrobials from herbs and spices. In: Natural Antimicrobials for the Minimal Processing of Foods. Ed: S. Roller. CRC Press. Washington, USA.
7. Smid, E. J. and Gorris, L. G. M. 1999. Natural antimicrobials for food preservation. In: Handbook of Food Preservation. Ed: M. S. Rahman. Marcel Dekker Inc. New York.
8. Loliger, J. 1989. Natural Antioxidants. In: Rancidity in Food, edited by J. Allen and R. Hamilton. Elsevier Applied Science, New York, pp 105-124
9. Cuvelier, M. 0E., Richard, H., and Berset, C. 1996. Antioxidative activity and phenolic composition of pilot-plant and commercial extracts of sage and rosemary. JAOCS 73: 645-652
10. U.S. Pat. No. 6,231,896
11. Wenkert et al. J. Org. Chem. 30:2931, 1965)

All publications mentioned in the above specification are herein incorporated by reference. Various modifications and variations of the described methods and system of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention which are obvious to those skilled in chemistry, biology, food science or related fields are intended to be within the scope of the following claims

1. A foodstuff in the form of a spread, wherein the spread is a water in oil emulsion containing an anti-oxidant composition comprising
(a) an extract obtained from or obtainable from a plant of the Labiatae family,
(b) an extract obtained from or obtainable from a plant of the genus Matricaria or of the genus Chamaemelum.

2. A spread according to claim 1 wherein the composition comprises
(a) an extract obtained from a plant of the Labiatae family.

3. A spread according to claim 1 wherein the composition comprises
(b) an extract obtained from a plant of the genus Matricaria or of the genus Chamaemelum.

4. A spread according to claim 1 wherein the plant of the Labiatae family is selected from rosemary, sage, oregano, marjoram, mint, balm, savoury, and thyme.

5. A spread according to claim 1 wherein the plant of the Labiatae family is rosemary.

6. A spread according to claim 1 wherein extract (b) if from a plant of the genus Matricaria.

7. A spread according to claim 1 wherein extract (b) is from a plant of the species Matricaria recurtita.

8. A spread according to claim 1 further comprising
(c) an extract obtained from or obtainable from a plant of the Cynara family.

9. A spread according to claim 8 wherein the composition comprises
(c) an extract obtained from a plant of the Cynara family.

10. A spread according to claim 8 wherein the plant of the Cynara family is selected from Cynara scolymus and Cynara cardunculus.

11. A spread according to claim 8 wherein the plant of the Cynara family is Cynara scolymus.

12. A spread according to claim 1 wherein the extract obtained from or obtainable from a plant of the Labiatae family contains phenolic diterpenes in an amount of at least 1 wt % based on the weight of extract obtained from or obtainable from a plant of the Labiatae family.

13. A spread according to claim 1 wherein the extract obtained from or obtainable from a plant of the Labiatae family contains carnosic acid in an amount of at least 1 wt % based on the weight of extract obtained from or obtainable from a plant of the Labiatae family.

14. A spread according to claim 1 wherein the extract obtained from or obtainable from the plant of the genus Matricaria or of the genus Chamaemelum contains apigenin-7-O-glucoside in an amount of at least 0.1 wt % based on the weight of extract obtained from or obtainable from the plant the plant of the genus Matricaria or of the genus Chamaemelum.

15. A spread according to claim 1 wherein ratio of
(a) extract obtained from or obtainable from a plant of the Labiatae family to
(b) extract obtained from or obtainable from a plant of the genus Matricaria or of the genus Chamaemelum
is from 30:1 to 1:20.

16. A spread according to claim 1 wherein (a) the extract obtained from or obtainable from a plant of the Labiatae family, and (b) the extract obtained from or obtainable from a plant Matricaria or Chamaemelum sp.
are present in amounts to provide a synergistic anti-oxidant effect.

17. A spread according to claim 1 wherein in use the antioxidant inhibits the formation of hexanal, 2,4-heptadienal and/or 2,4-decadienal.

18. A process for preventing and/or inhibiting oxidation of a foodstuff which is in the form of a spread, wherein the spread is a water in oil emulsion, the process comprising the step of contacting the spread with or incorporating in the spread
(a) an extract obtained from or obtainable from a plant of the Labiatae family, and
(b) an extract obtained from or obtainable from a plant of the genus Matricaria or of the genus Chamaemelum.

19. A process according to claim 18 wherein
(a) an extract obtained from or obtainable from a plant of the Labiatae family, and
(b) an extract obtained from or obtainable from a plant of the genus Matricaria or of the genus Chamaemelum,
are mixed with the foodstuff together.

20. A process according to claim 18 wherein
(a) an extract obtained from or obtainable from a plant of the Labiatae family, and
(b) an extract obtained from or obtainable from a plant of the genus Matricaria or of the genus Chamaemelum,
are mixed with the foodstuff sequentially.
